(19) United States
(12) Patent Application Publication
(10) Pub. No.: US 2026/0129538 A1
(43) Pub. Date: May 7, 2026

(54) DATA BURST INTERVAL AWARENESS FOR HANDOVER PROCEDURES

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/939,028

(22) Filed: Nov. 6, 2024

(51) Int. Cl. H04W 36/24; H04W 24/10

(52) U.S. Cl. CPC H04W 36/24; H04W 24/10

(57) ABSTRACT

Various aspects of the present disclosure generally relate to wireless communication. In some aspects, a user equipment (UE) may transmit, to a source network node, a report that indicates a data burst interval and indicates whether to delay handover execution based on the data burst interval. The UE may receive, from the source network node, a command associated with a handover from the source network node to a target network node, where the command is received before or after a data burst based on the data burst interval and one or more handover delay rules. The UE may perform the handover based on receiving the command. In some aspects, the UE may receive a command indicating one or more conditions associated with the handover, where the command indicates the one or more handover delay rules. Numerous other aspects are described.

### FIELD OF THE DISCLOSURE

Aspects of the present disclosure generally relate to wireless communication and specifically relate to techniques, apparatuses, and methods associated with data burst interval awareness for handover procedures

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to transmit, to a source network node, a report that indicates a data burst interval and indicates whether to delay handover execution based at least in part on the data burst interval. The one or more processors may be configured to receive, from the source network node, a command associated with a handover from the source network node to a target network node, wherein the command is received before or after a data burst based at least in part on the data burst interval and one or more handover delay rules. The one or more processors may be configured to perform the handover based at least in part on receiving the command.

Some aspects described herein relate to a UE for wireless communication. The UE may include one or more memories and one or more processors coupled to the one or more memories. The one or more processors may be configured to receive, from a source network node, a command indicating one or more conditions associated with a handover from the source network node to a target network node, wherein the command indicates one or more handover delay rules associated with whether to delay execution of the handover in accordance with a data burst interval. The one or more processors may be configured to perform, in accordance with the one or more conditions being satisfied, the handover to the target network node before or after a data burst based at least in part on the data burst interval and one or more handover delay rules.

Some aspects described herein relate to a source network node for wireless communication. The source network node may include one or more memories and one or more processors coupled to the one or more memories. The one or more processors may be configured to receive, from a UE, a report that indicates a data burst interval and indicates whether to delay handover execution based at least in part on the data burst interval. The one or more processors may be configured to transmit, to the UE, a command associated with a handover from the source network node to a target network node, wherein the command is received before or after a data burst based at least in part on the data burst interval and one or more handover delay rules. The one or more processors may be configured to release, in accordance with the handover, a wireless connection with the UE before or after the data burst, based at least in part on the command.

Some aspects described herein relate to a source network node for wireless communication. The source network node may include one or more memories and one or more processors coupled to the one or more memories. The one or more processors may be configured to transmit, to a UE, a command indicating one or more conditions associated with a handover of the UE from the source network node to a target network node, wherein the command indicates one or more handover delay rules associated with whether to delay execution of the handover in accordance with a data burst interval. The one or more processors may be configured to release, in accordance with the handover for the UE to the target network node and in accordance with the one or more conditions being satisfied, a wireless connection with the UE before or after a data burst, based at least in part on the data burst interval and one or more handover delay rules.

Some aspects described herein relate to a method of wireless communication performed by a UE. The method may include transmitting, to a source network node, a report that indicates a data burst interval and indicates whether to delay handover execution based at least in part on the data burst interval. The method may include receiving, from the source network node, a command associated with a handover from the source network node to a target network node, wherein the command is received before or after a data burst based at least in part on the data burst interval and one or more handover delay rules. The method may include performing the handover based at least in part on receiving the command.

Some aspects described herein relate to a method of wireless communication performed by a UE. The method may include receiving, from a source network node, a command indicating one or more conditions associated with a handover from the source network node to a target network node, wherein the command indicates one or more handover delay rules associated with whether to delay execution of the handover in accordance with a data burst interval. The method may include performing, in accordance with the one or more conditions being satisfied, the handover to the target network node before or after a data burst based at least in part on the data burst interval and one or more handover delay rules.

Some aspects described herein relate to a method of wireless communication performed by a source network node. The method may include receiving, from a UE, a report that indicates a data burst interval and indicates whether to delay handover execution based at least in part on the data burst interval. The method may include transmitting, to the UE, a command associated with a handover from the source network node to a target network node, wherein the command is received before or after a data burst based at least in part on the data burst interval and one or more handover delay rules. The method may include releasing, in accordance with the handover, a wireless connection with the UE before or after the data burst, based at least in part on the command.

Some aspects described herein relate to a method of wireless communication performed by a source network node. The method may include transmitting, to a UE, a command indicating one or more conditions associated with a handover of the UE from the source network node to a target network node, wherein the command indicates one or more handover delay rules associated with whether to delay execution of the handover in accordance with a data burst interval. The method may include releasing, in accordance with the handover for the UE to the target network node and in accordance with the one or more conditions being satisfied, a wireless connection with the UE before or after a data burst, based at least in part on the data burst interval and one or more handover delay rules.

Some aspects described herein relate to a non-transitory computer-readable medium that stores a set of instructions for wireless communication by a UE. The set of instructions, when executed by one or more processors of the UE, may cause the UE to transmit, to a source network node, a report that indicates a data burst interval and indicates whether to delay handover execution based at least in part on the data burst interval. The set of instructions, when executed by one or more processors of the UE, may cause the UE to receive, from the source network node, a command associated with a handover from the source network node to a target network node, wherein the command is received before or after a data burst based at least in part on the data burst interval and one or more handover delay rules. The set of instructions, when executed by one or more processors of the UE, may cause the UE to perform the handover based at least in part on receiving the command.

Some aspects described herein relate to a non-transitory computer-readable medium that stores a set of instructions for wireless communication by a UE. The set of instructions, when executed by one or more processors of the UE, may cause the UE to receive, from a source network node, a command indicating one or more conditions associated with a handover from the source network node to a target network node, wherein the command indicates one or more handover delay rules associated with whether to delay execution of the handover in accordance with a data burst interval. The set of instructions, when executed by one or more processors of the UE, may cause the UE to perform, in accordance with the one or more conditions being satisfied, the handover to the target network node before or after a data burst based at least in part on the data burst interval and one or more handover delay rules.

Some aspects described herein relate to a non-transitory computer-readable medium that stores a set of instructions for wireless communication by a source network node. The set of instructions, when executed by one or more processors of the source network node, may cause the source network node to receive, from a UE, a report that indicates a data burst interval and indicates whether to delay handover execution based at least in part on the data burst interval. The set of instructions, when executed by one or more processors of the source network node, may cause the source network node to transmit, to the UE, a command associated with a handover from the source network node to a target network node, wherein the command is received before or after a data burst based at least in part on the data burst interval and one or more handover delay rules. The set of instructions, when executed by one or more processors of the source network node, may cause the source network node to release, in accordance with the handover, a wireless connection with the UE before or after the data burst, based at least in part on the command.

Some aspects described herein relate to a non-transitory computer-readable medium that stores a set of instructions for wireless communication by a source network node. The set of instructions, when executed by one or more processors of the source network node, may cause the source network node to transmit, to a UE, a command indicating one or more conditions associated with a handover of the UE from the source network node to a target network node, wherein the command indicates one or more handover delay rules associated with whether to delay execution of the handover in accordance with a data burst interval. The set of instructions, when executed by one or more processors of the source network node, may cause the source network node to release, in accordance with the handover for the UE to the target network node and in accordance with the one or more conditions being satisfied, a wireless connection with the UE before or after a data burst, based at least in part on the data burst interval and one or more handover delay rules.

Some aspects described herein relate to an apparatus for wireless communication. The apparatus may include means for transmitting, to a source network node, a report that indicates a data burst interval and indicates whether to delay handover execution based at least in part on the data burst interval. The apparatus may include means for receiving, from the source network node, a command associated with a handover from a source network node to a target network node, wherein the command is received before or after a data burst based at least in part on the data burst interval and one or more handover delay rules. The apparatus may include means for performing the handover based at least in part on receiving the command.

Some aspects described herein relate to an apparatus for wireless communication. The apparatus may include means for receiving, from a source network node, a command indicating one or more conditions associated with a handover from the source network node to a target network node, wherein the command indicates one or more handover delay rules associated with whether to delay execution of the handover in accordance with a data burst interval. The apparatus may include means for performing, in accordance with the one or more conditions being satisfied, the handover to the target network node before or after a data burst based at least in part on the data burst interval and one or more handover delay rules.

Some aspects described herein relate to an apparatus for wireless communication. The apparatus may include means for receiving, from a UE, a report that indicates a data burst interval and indicates whether to delay handover execution based at least in part on the data burst interval. The apparatus may include means for transmitting, to the UE, a command associated with a handover from a source network node to a target network node, wherein the command is received before or after a data burst based at least in part on the data burst interval and one or more handover delay rules. The apparatus may include means for releasing, in accordance with the handover, a wireless connection with the UE before or after the data burst, based at least in part on the command.

Some aspects described herein relate to an apparatus for wireless communication. The apparatus may include means for transmitting, to a UE, a command indicating one or more conditions associated with a handover of the UE from a source network node to a target network node, wherein the command indicates one or more handover delay rules associated with whether to delay execution of the handover in accordance with a data burst interval. The apparatus may include means for releasing, in accordance with the handover for the UE to the target network node and in accordance with the one or more conditions being satisfied, a wireless connection with the UE before or after a data burst, based at least in part on the data burst interval and one or more handover delay rules.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a layer 3 handover procedure, in accordance with the present disclosure.

FIG. 4 is a diagram illustrating an example of a conditional handover procedure, in accordance with the present disclosure.

FIG. 5 is a diagram illustrating an example of a layer 1 or layer 2 triggered mobility procedure, in accordance with the present disclosure.

FIG. 6 is a diagram illustrating an example associated with a user equipment (UE) performing a handover procedure without considering a data burst interval, in accordance with the present disclosure.

FIG. 7 is a diagram illustrating an example associated with data burst awareness for handover procedures initiated by a command, in accordance with the present disclosure.

FIG. 8 is a diagram illustrating an example associated with data burst awareness for conditional handover procedures, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a source network node or an apparatus of a source network node, in accordance with the present disclosure.

FIG. 12 is a diagram illustrating an example process performed, for example, at a source network node or an apparatus of a source network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communications networks, a user equipment (UE) and source network node may communicate one or more data bursts. For example, a data burst may refer to a short period of time during which a large volume of data is transmitted in rapid succession (e.g., a volume of data that satisfies a threshold over a duration of time that satisfies a threshold). Additionally, there are typically periods of lower data transmission or inactivity between data bursts. In some examples, the data bursts can occur in both the uplink direction (from the UE to the source network node) and/or the downlink direction (from the source network node to the UE), depending on a type of application and/or one or more characteristics associated with the data exchange. In some examples, data burst intervals may refer to respective durations of time between consecutive data bursts. Such data burst intervals can vary based on the type of data included in the data bursts and/or network conditions, among other factors. For instance, a video streaming service may generate bursts at regular and/or periodic intervals as video segments are buffered and transmitted, while a real-time game may produce irregular bursts based on in-game events or player actions. Therefore, the source network node may analyze one or more characteristics associated with the data burst intervals to allocate resources efficiently and provide a seamless playback of the data included in the data bursts. Additionally, the data bursts (e.g., in the uplink and/or downlink direction) may be associated with an application operating at the UE. For example, the application may be associated with one or more of extended reality (XR) information, real-time multiplayer video games, or video streaming.

In some examples, the UE may operate in accordance with a handover procedure. For example, the UE may establish a wireless link with the target network node and may release the wireless link with the source network node. In some examples, the UE may perform the handover from the source network node to the target network node in accordance with one or more types of handover (e.g., a layer 3 (L3) handover procedure, a conditional handover (CHO) procedure, or a layer 1 or layer 2 triggered mobility (LTM) procedure). In some examples, the handover of the UE from the source network node to the target network node may occur while the application is operating at the UE. For instance, the UE may be prepared and/or scheduled to transmit an uplink data burst associated with the application to the source network node. Additionally, or alternatively, the source network node may be prepared and/or scheduled to transmit a downlink data burst associated with the application to the UE. In some cases, however, the UE may perform the handover to the target network node before transmission of an uplink data burst and/or reception of a downlink data burst. In such cases, the UE and the source network node may not communicate the one or more data bursts. Rather, the UE may communicate the one or more data bursts with the target network node after completion of the handover procedure. Therefore, the handover procedure may cause data interruption during which the UE may not transmit or receive any data bursts associated with the application.

By not considering data burst intervals while preforming a handover, one or more data bursts associated with application may be delayed. In examples where the data associated with application is delay-sensitive, delaying communication of the data bursts may reduce performance of the application (e.g., degrade user experience). In some examples, the delay may cause buffer underflows and/or overflows at the UE. Additionally, or alternatively, the data burst delays may result in resource allocation challenges. For example, the UE may allocate resources (such as processing power, memory, and network bandwidth) to maintain smooth operation of data. Therefore, delays in data transmission and/or reception may result in the UE reallocating the resources, which may disrupt efficient functioning of the UE. Additionally, or alternatively, the delay in data bursts may increase network overhead. The source network node may send, to the target network node, downlink data that the source network node did not transmit to the UE before the handover. Therefore, the source network node and target network node may allocate resources to forward data bursts associated with the UE to the target network node, which may increase network overhead.

Various aspects of the present disclosure may increase data burst interval awareness of handover procedures at the source network node and/or the UE. For example, in some aspects, the source network node may transmit, and the UE may receive, an indication of one or more handover delay rules to determine whether to delay handover in accordance with a data burst interval. For example, the one or more handover delay rules may be associated with one or more of a predicted arrival time of a data burst, a source network node scheduling rate, a measurement associated with the source network node, or a duration for delaying the handover. In accordance with the one or more handover delay rules, the UE and/or the source network node may determine whether to transmit one or more data bursts (via uplink and/or downlink) before or after a handover procedure. In cases of a handover triggered by a network handover command (e.g., an L3 handover command or an LTM cell switch command), the UE may transmit a data burst interval report that indicates an uplink burst status and indicates a request for the source network node to delay transmission of a handover command. In accordance with the data burst interval report and/or a predicted arrival time for the UE to receive a data burst via downlink, the source network node may determine whether to communicate one or more data bursts before transmitting the handover command (e.g., delay the handover command) or communicate the one or more data bursts after transmitting the handover command. In cases of a CHO procedure, the UE may use the one or more handover delay rules to determine whether to delay the CHO procedure in accordance with communication of one or more data bursts. For example, when the UE determines that one or more conditions associated with a CHO command are satisfied, the UE may determine whether to communicate one or more data bursts before executing the CHO command or communicate the one or more data bursts after executing the CHO command (e.g., based on an uplink burst status and/or downlink scheduling information that indicates a downlink burst status).

In some aspects, the UE may transmit capability information that indicates support for the delaying handover procedures in accordance with data burst intervals. In some aspects, the UE may receive the one or more handover delay rules in accordance with the capability information.

Particular aspects of the subject matter described in this disclosure can be implemented to realize one or more of the following potential advantages. In some examples, the described techniques can be used to reduce delay associated with the communication of data bursts. For example, if channel conditions between the source network node and the UE is satisfactory (e.g., channel quality satisfies a threshold) to permit reliable downlink and/or uplink communication, then the UE and source network node may prioritize the communication of data bursts over performing the handover. Therefore, in examples where the data bursts are associated with delay-sensitive data, the UE and the source network node may reduce the latency associated with communication of data bursts, which may reduce data interruption associated with performing handover. Additionally, the described techniques may reduce network overhead. For example, by transmitting one or more data packets to the UE before the handover procedure, the source network node may reduce the number of data packets sent to the target network node for forwarding to the UE after the handover is complete.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

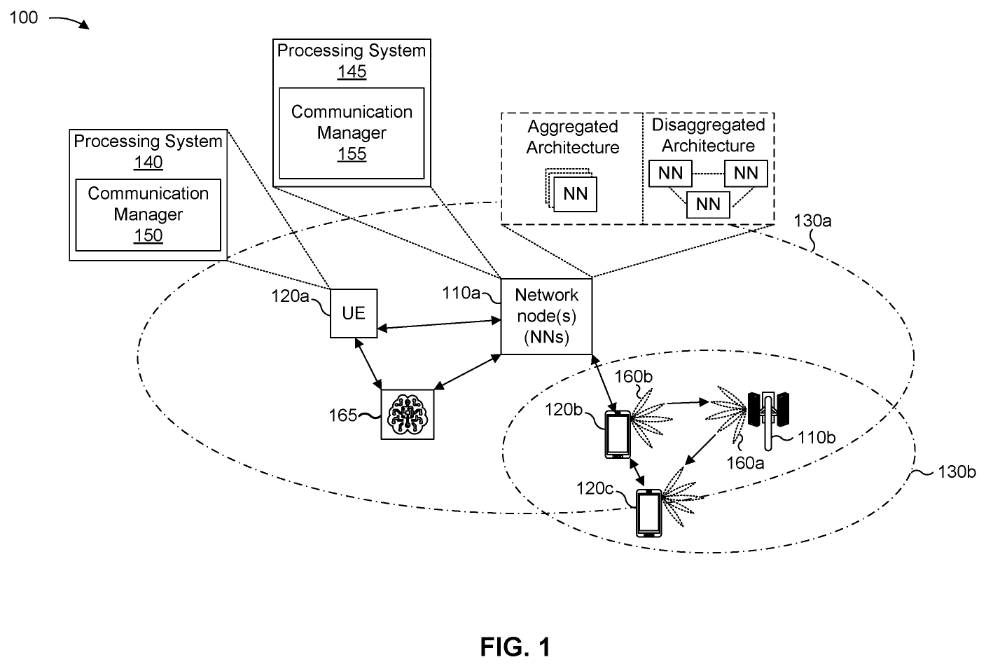

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

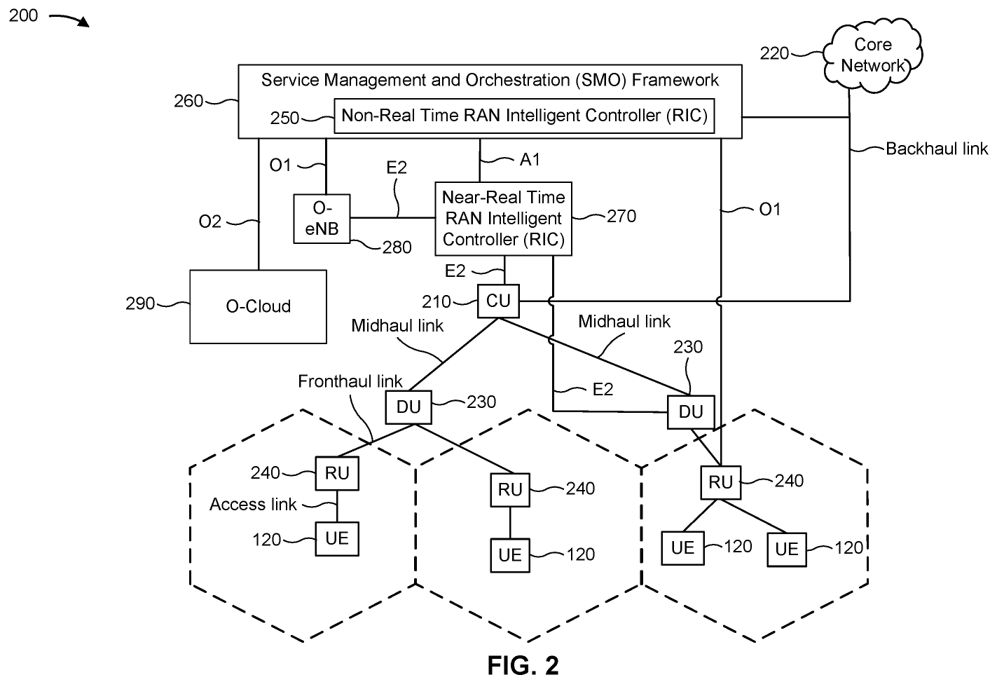

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may transmit, to a source network node, a report that indicates a data burst interval and indicates whether to delay handover execution based at least in part on the data burst interval; receive, from the source network node, a command associated with a handover from the source network node to a target network node, wherein the command is received before or after a data burst based at least in part on the data burst interval and one or more handover delay rules; and perform the handover based at least in part on receiving the command. Additionally, or alternatively, the communication manager 150 may receive, from a source network node, a command indicating one or more conditions associated with a handover from the source network node to a target network node, wherein the command indicates one or more handover delay rules associated with whether to delay execution of the handover in accordance with a data burst interval; and perform, in accordance with the one or more conditions being satisfied, the handover to the target network node before or after a data burst based at least in part on the data burst interval and one or more handover delay rules. Additionally, or alternatively, the communication manager 150 may perform one or more other operations described herein.

In some aspects, the network node 110 may include a communication manager 155. As described in more detail elsewhere herein, the communication manager 155 may receive, from a UE, a report that indicates a data burst interval and indicates whether to delay handover execution based at least in part on the data burst interval; transmit, to the UE, a command associated with a handover from the source network node to a target network node, wherein the command is received before or after a data burst based at least in part on the data burst interval and one or more handover delay rules; and release, in accordance with the handover, a wireless connection with the UE before or after the data burst, based at least in part on the command. Additionally, or alternatively, the communication manager 155 may transmit, to a UE, a command indicating one or more conditions associated with a handover of the UE from the source network node to a target network node, wherein the command indicates one or more handover delay rules associated with whether to delay execution of the handover in accordance with a data burst interval; and release, in accordance with the handover for the UE to the target network node and in accordance with the one or more conditions being satisfied, a wireless connection with the UE before or after a data burst, based at least in part on the data burst interval and one or more handover delay rules. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

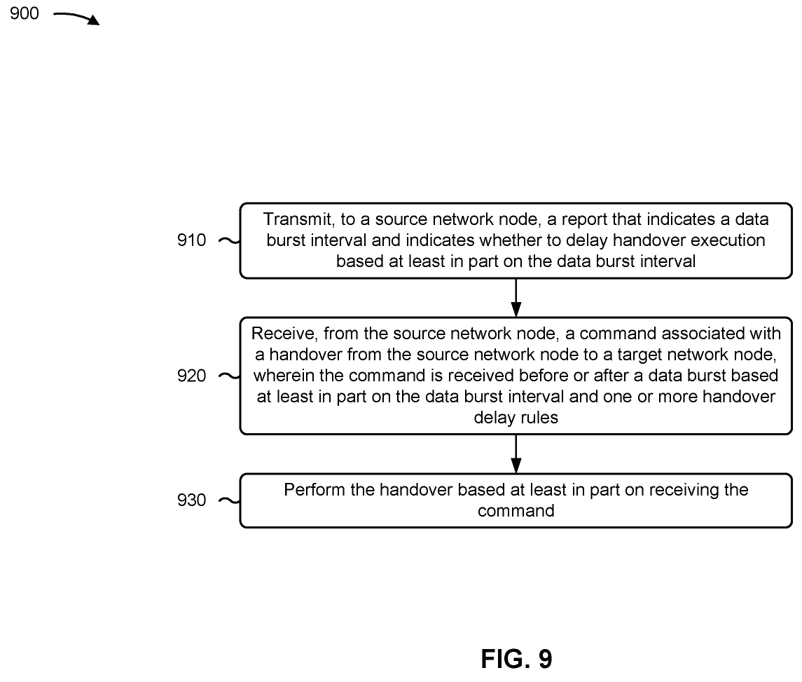

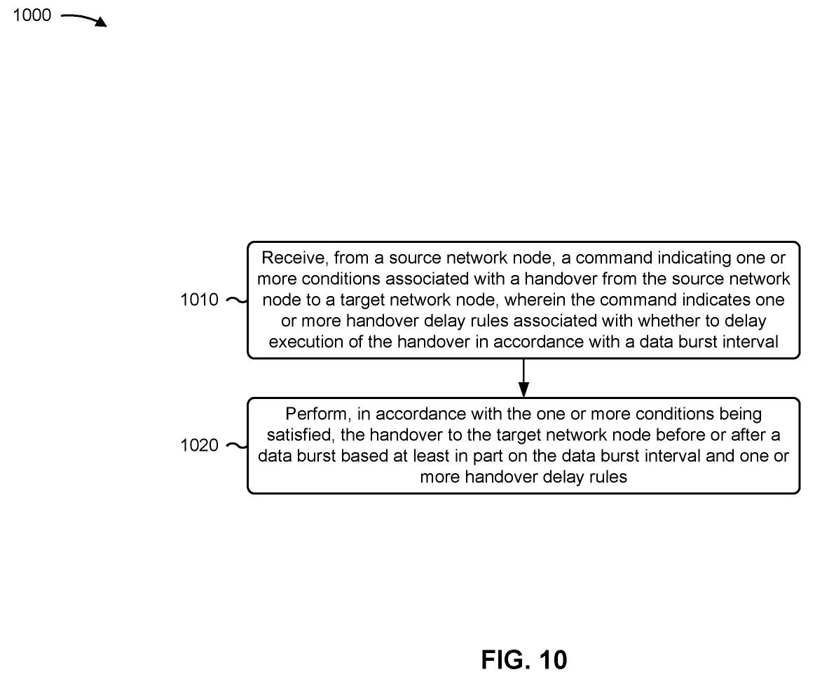

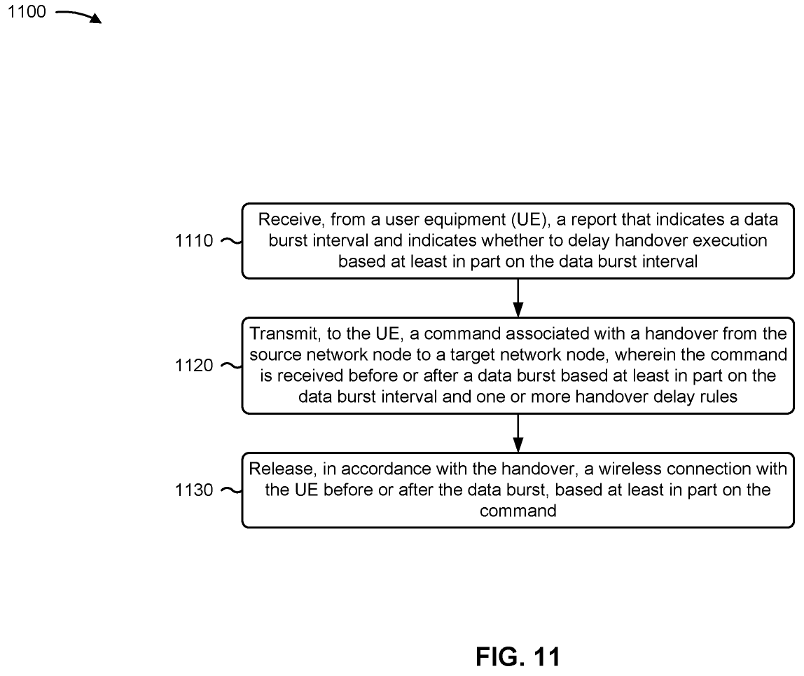

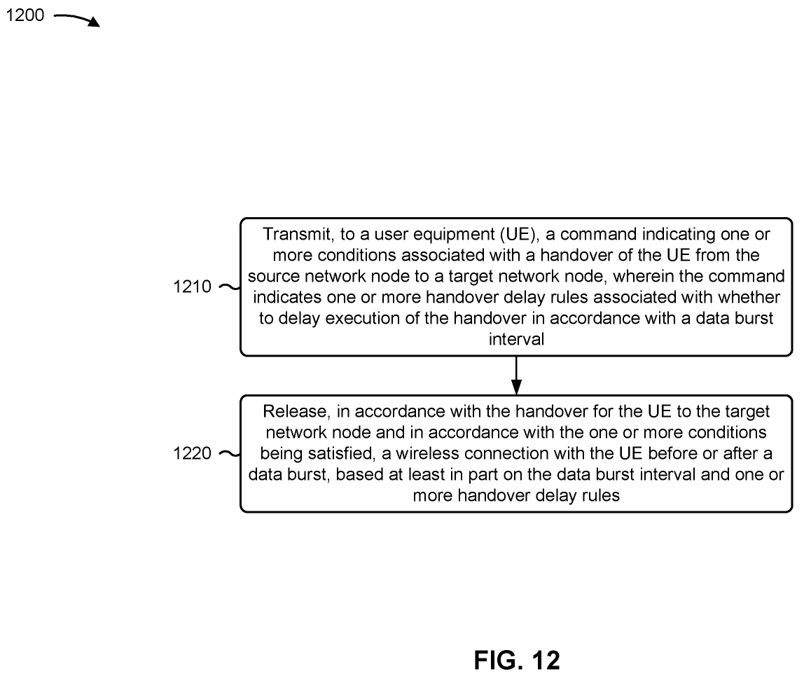

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with data burst interval awareness for handover procedures, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples.

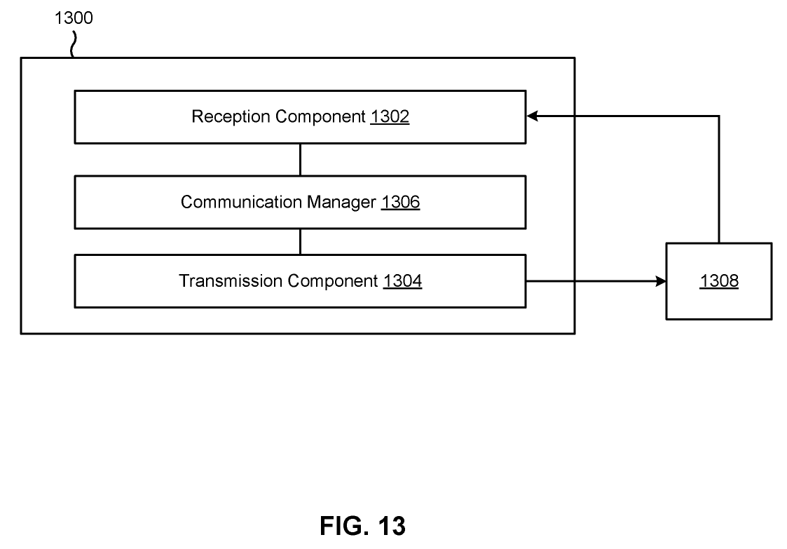

In some aspects, the UE 120 includes means for transmitting, to a source network node, a report that indicates a data burst interval and indicates whether to delay handover execution based at least in part on the data burst interval; means for receiving, from the source network node, a command associated with a handover from the source network node to a target network node, wherein the command is received before or after a data burst based at least in part on the data burst interval and one or more handover delay rules; and/or means for performing the handover based at least in part on receiving the command. Additionally, or alternatively, the UE 120 includes means for receiving, from a source network node, a command indicating one or more conditions associated with a handover from the source network node to a target network node, wherein the command indicates one or more handover delay rules associated with whether to delay execution of the handover in accordance with a data burst interval; and/or means for performing, in accordance with the one or more conditions being satisfied, the handover to the target network node before or after a data burst based at least in part on the data burst interval and one or more handover delay rules. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

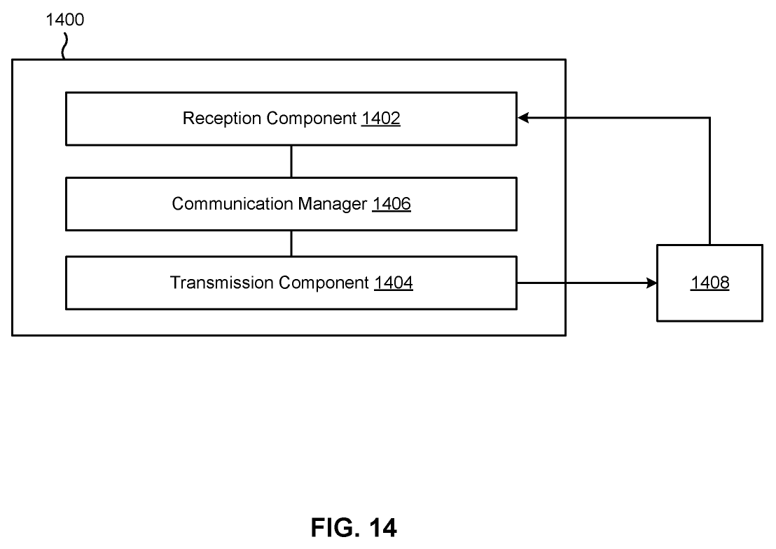

In some aspects, the source network node 110 includes means for receiving, from a UE, a report that indicates a data burst interval and indicates whether to delay handover execution based at least in part on the data burst interval; means for transmitting, to the UE, a command associated with a handover from the source network node to a target network node, wherein the command is received before or after a data burst based at least in part on the data burst interval and one or more handover delay rules; and/or means for releasing, in accordance with the handover, a wireless connection with the UE before or after the data burst, based at least in part on the command. Additionally, or alternatively, the source network node 110 includes means for transmitting, to a UE, a command indicating one or more conditions associated with a handover of the UE from the source network node to a target network node, wherein the command indicates one or more handover delay rules associated with whether to delay execution of the handover in accordance with a data burst interval; and/or means for releasing, in accordance with the handover for the UE to the target network node and in accordance with the one or more conditions being satisfied, a wireless connection with the UE before or after a data burst, based at least in part on the data burst interval and one or more handover delay rules. The means for the source network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

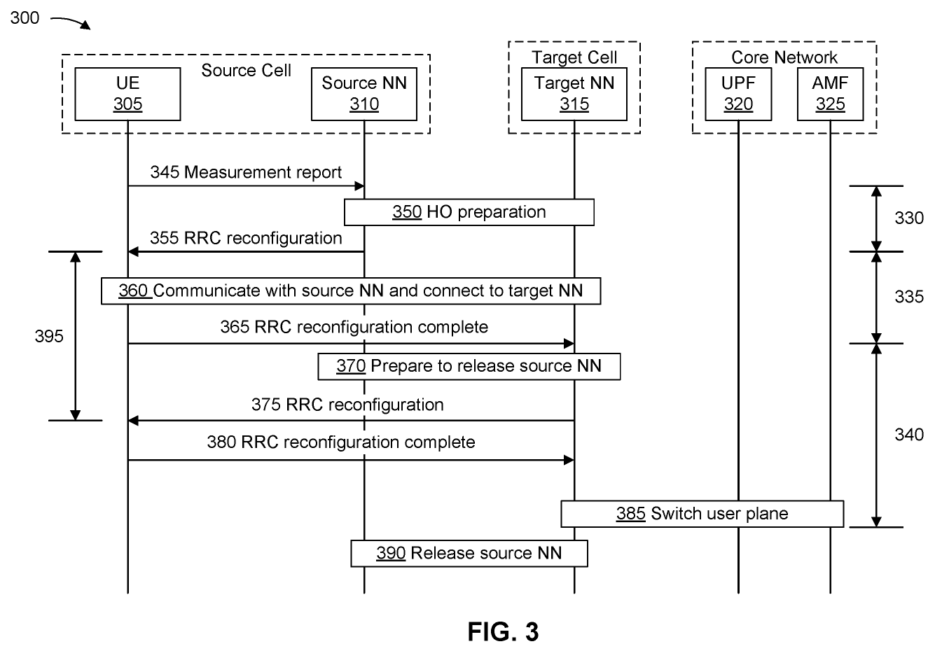

FIG. 3 is a diagram illustrating an example 300 of a layer 3 (L3) handover procedure, in accordance with the present disclosure.

As shown in FIG. 3, the L3 handover procedure may involve a UE 305, a source network node 310, a target network node 315, a user plane function (UPF) device 320, and an access and mobility function (AMF) device 325. In some examples, actions described as being performed by a network node may be performed by multiple network nodes. For example, configuration actions and/or core network communication actions may be performed by a first network node (e.g., a CU or a DU), and radio communication actions may be performed by a second network node (e.g., a DU or an RU). The UE 305 may correspond to the UE 120 described elsewhere herein. The source network node 310 and/or the target network node 315 may correspond to the network node 110 described elsewhere herein. The UE 305 and the source network node 310 may be connected (e.g., may have an RRC connection) via a serving cell or a source cell, and the UE 305 may undergo a handover to the target network node 315 via a target cell. The UPF device 320 and/or the AMF device 325 may be located within a core network. The source network node 310 and the target network node 315 may be in communication with the core network for mobility support and user plane functions.

As shown in FIG. 3, the L3 handover procedure may include a handover preparation phase 330, a handover execution phase 335, and a handover completion phase 340. During the handover preparation phase 330, the UE 305 may report measurements that cause the source network node 310 and/or the target network node 315 to prepare for handover and trigger execution of the handover. During the handover execution phase 335, the UE 305 may execute the handover by performing a random access procedure with the target network node 315 and establishing an RRC connection with the target network node 315. During the handover completion phase 340, the source network node 310 may forward one or more stored communications associated with the UE 305 to the target network node 315, and the UE 305 may be released from a connection with the source network node 310.

As shown by reference number 345, during the handover preparation phase 330, the UE 305 may perform one or more measurements, and may transmit a measurement report to the source network node 310 based at least in part on the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 310 may use the measurement report to determine whether to trigger a handover to the target network node 315. For example, if one or more measurements satisfy a condition, the source network node 310 may trigger a handover of the UE 305 to the target network node 315.

As shown by reference number 350, during the handover preparation phase 330, the source network node 310 and the target network node 315 may communicate with one another to prepare for a handover of the UE 305. As part of the handover preparation, the source network node 310 may transmit a handover request to the target network node 315 to instruct the target network node 315 to prepare for the handover. The source network node 310 may communicate RRC context information associated with the UE 305 and/or configuration information associated with the UE 305 to the target network node 315. The target network node 315 may prepare for the handover by reserving resources for the UE 305. After reserving the resources, the target network node 315 may transmit an acknowledgement (ACK) to the source network node 310 in response to the handover request.

As shown by reference number 355, during the handover preparation phase 330, the source network node 310 may transmit an RRC reconfiguration message to the UE 305. The RRC reconfiguration message may include a handover command instructing the UE 305 to execute a handover procedure from the source network node 310 to the target network node 315. The handover command may include information associated with the target network node 315, such as a random access channel (RACH) preamble assignment for accessing the target network node 315. Reception of the RRC reconfiguration message, including the handover command, by the UE 305 may trigger the start of the handover execution phase 335.

As shown by reference number 360, during the handover execution phase 335, the UE 305 may execute the handover by performing a random access procedure with the target network node 315 (e.g., including synchronization with the target network node 315) while continuing to communicate with the source network node 310. For example, while the UE 305 is performing the random access procedure with the target network node 315, the UE 305 may transmit uplink data, uplink control information, and/or an uplink reference signal (e.g., an SRS) to the source network node 310, and/or may receive downlink data, DCI, and/or a downlink reference signal from the source network node 310.

As shown by reference number 365, upon successfully establishing a connection with the target network node 315 (e.g., via a random access procedure) during the handover execution phase 335, the UE 305 may transmit an RRC reconfiguration completion message to the target network node 315. Reception of the RRC reconfiguration message by the target network node 315 may trigger the start of the handover completion phase 340.

As shown by reference number 370, during the handover completion phase 340, the source network node 310 and the target network node 315 may communicate with one another to prepare for release of the connection between the source network node 310 and the UE 305. In some aspects, the target network node 315 may determine that a connection between the source network node 310 and the UE 305 is to be released, such as after receiving the RRC reconfiguration message from the UE 305. In this case, the target network node 315 may transmit a handover connection setup completion message to the source network node 310. The handover connection setup completion message may cause the source network node 310 to stop transmitting data to the UE 305 and/or to stop receiving data from the UE 305. Additionally, or alternatively, the handover connection setup completion message may cause the source network node 310 to forward communications associated with the UE 305 to the target network node 315 and/or to notify the target network node 315 of a status of one or more communications with the UE 305. For example, the source network node 310 may forward, to the target network node 315, buffered downlink communications (e.g., downlink data) for the UE 305 and/or uplink communications (e.g., uplink data) received from the UE 305. Additionally, or alternatively, the source network node 310 may notify the target network node 315 regarding a PDCP status associated with the UE 305 and/or a sequence number to be used for a downlink communication with the UE 305.

As shown by reference number 375, during the handover completion phase 340, the target network node 315 may transmit an RRC reconfiguration message to the UE 305 to instruct the UE 305 to release the connection with the source network node 310. Upon receiving the instruction to release the connection with the source network node 310, the UE 305 may stop communicating with the source network node 310. For example, the UE 305 may refrain from transmitting uplink communications to the source network node 310 and/or may refrain from monitoring for downlink communications from the source network node 310.

As shown by reference number 380, during the handover completion phase 340, the UE may transmit an RRC reconfiguration completion message to the target network node 315 to indicate that the connection between the source network node 310 and the UE 305 is being released or has been released.

As shown by reference number 385, during the handover completion phase 340, the target network node 315, the UPF device 320, and/or the AMF device 325 may communicate to switch a user plane path of the UE 305 from the source network node 310 to the target network node 315. Prior to switching the user plane path, downlink communications for the UE 305 may be routed through the core network to the source network node 310. After the user plane path is switched, downlink communications for the UE 305 may be routed through the core network to the target network node 315. Upon completing the switch of the user plane path, the AMF device 325 may transmit an end marker message to the source network node 310 to signal completion of the user plane path switch. As shown by reference number 390, the target network node 315 and the source network node 310 may communicate to release the source network node 310.

As part of the L3 handover procedure, the UE 305 may maintain simultaneous connections with the source network node 310 and the target network node 315 during a time period 395. The time period 395 may start at the beginning of the handover execution phase 335 (e.g., upon reception by the UE 305 of a handover command from the source network node 310) when the UE 305 performs a random access procedure with the target network node 315. The time period 395 may end upon release of the connection between the UE 305 and the source network node 310 (e.g., upon reception by the UE 305 of an instruction, from the target network node 315, to release the source network node 310). By maintaining simultaneous connections with the source network node 310 and the target network node 315, the handover procedure can be performed with zero or a minimal interruption to communications, thereby reducing latency.

As indicated above, FIG. 3 is provided as an example. Other examples may differ from what is described with regard to FIG. 3.

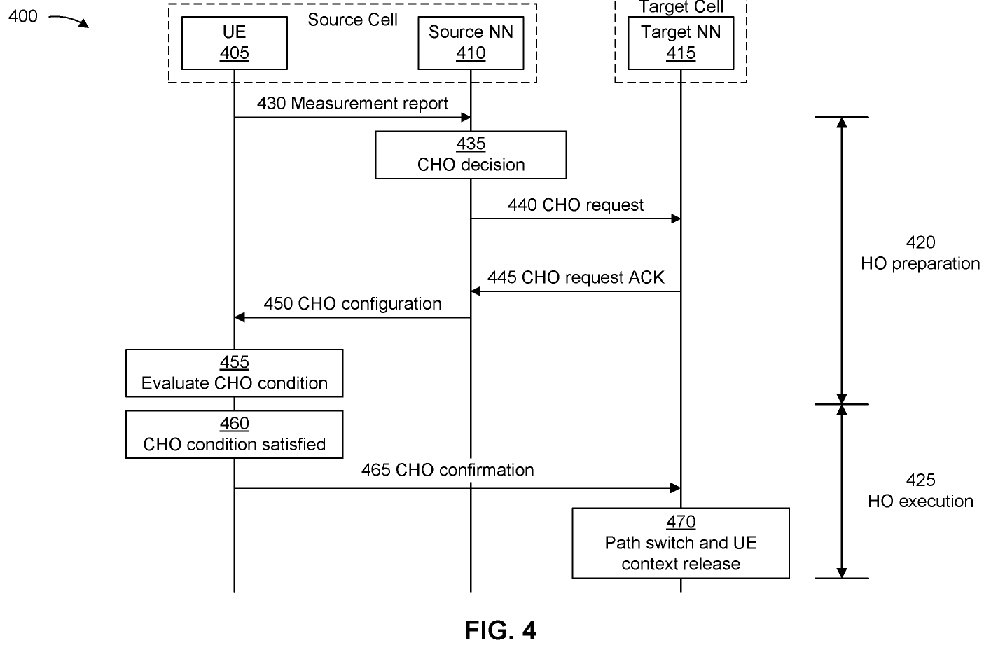

FIG. 4 is a diagram illustrating an example 400 of a conditional handover procedure in accordance with the present disclosure. As shown in FIG. 4, the conditional handover procedure may involve a UE 405, a source network node 410, and a target network node 415. In some examples, actions described as being performed by a network node may be performed by multiple network nodes. The UE 405 and the source network node 410 may be connected (e.g., may have an RRC connection) via a serving cell or a source cell, and the UE 405 may undergo a conditional handover to the target network node 415 via a target cell.

As shown in FIG. 4, the conditional handover procedure may include a handover preparation phase 420 and a handover execution phase 425. During the handover preparation phase 420, the source network node 410 may prepare one or more candidate target cells in advance, and may send a conditional handover configuration to the UE 405 when radio conditions between the UE 405 and the source network node 410 are not degraded. When the conditional handover configuration is received, the UE 405 stores a conditional handover message, and applies the stored conditional handover message only when a configured condition is satisfied for a configured candidate target cell. During the handover execution phase 425, the UE 405 may execute the handover by performing a random access procedure with the target network node 415 and establishing an RRC connection with the target network node 415 based on a configured condition being satisfied for the target network node 415. Accordingly, as described herein, the conditional handover procedure may reduce handover failure occurrences (e.g., where a handover is not triggered because a measurement report transmitted by the UE 405 does not reach the source network node 410 and/or because a handover command transmitted by the source network node 410 does not reach the UE 405 due to degraded signal conditions between the UE 405 and the source network node 410).

For example, as shown by reference number 430, during the handover preparation phase 420, the UE 405 may transmit, and the source network node 410 may receive, a measurement report that indicates measurements related to a signal strength (e.g., RSRP measurements, RSSI measurements, RSRQ measurements, and/or CQI values) or other suitable measurements associated with the source cell and/or one or more neighboring cells. In some examples, as shown by reference number 435, the source network node 410 may configure a conditional handover based on the measurement report provided by the UE 405 or other suitable information. For example, as shown by reference number 440, the source network node 410 may transmit a conditional handover request to the target network node 415 to instruct the target network node 415 to prepare for a potential handover. The source network node 410 may communicate RRC context information associated with the UE 405 and/or configuration information associated with the UE 405 to the target network node 415. The target network node 415 may prepare for the potential handover by reserving resources for the UE 405. After reserving the resources, as shown by reference number 445, the target network node 415 may transmit an ACK in response to the conditional handover request to the source network node 410.

As further shown by reference number 450, the source network node 410 may transmit, and the UE 405 may receive, a conditional handover configuration. For example, in some aspects, the conditional handover configuration may include a handover command to trigger a handover from the source network node 410 to the target network node 415, and the conditional handover configuration may further indicate one or more conditions associated with the conditional handover command. Accordingly, the UE 405 may generally store the conditional handover command, and may execute the conditional handover command only when an associated condition is satisfied. For example, in some aspects, the one or more conditions may instruct the UE 405 to execute the conditional handover command when a measurement associated with the source network node 410 fails to satisfy a threshold, when a difference between a measurement associated with the target network node 415 and a measurement associated with the source network node 410 satisfies a threshold, when a measurement associated with the target network node 415 satisfies a threshold, and/or when a measurement associated with the source network node 410 fails to satisfy a first threshold and a measurement associated with the target network node 415 satisfies a second threshold, among other examples.

Accordingly, as shown by reference number 455, the UE 405 may evaluate the conditional handover condition indicated by the source network node 410. For example, the UE 405 may obtain a measurement associated with the source network node 410 and/or a measurement associated with the target network node 415, and may determine whether the measurement associated with the source network node 410 and/or the measurement associated with the target network node 415 satisfy the condition associated with the conditional handover command. In cases where the condition associated with the conditional handover command is not satisfied, the UE 405 does not execute the conditional handover command, and may re-evaluate the condition associated with the conditional handover command at a later time. Alternatively, as shown by reference number 460, the UE 405 may determine that the condition associated with the conditional handover command is satisfied. In such cases, as shown by reference number 465, the UE 465 executes the conditional handover command, and communicates with the target network node 465 to confirm the conditional handover. As shown by reference number 470, the target network node 415 may perform a path switch to switch a user plane path of the UE 405 from the source network node 410 to the target network node 415. Prior to switching the user plane path, downlink communications for the UE 405 may be routed through the source network node 410. After the user plane path is switched, downlink communications for the UE 405 may be routed through the target network node 415. Upon completing the switch of the user plane path, a core network node may transmit an end marker message to the source network node 410 o signal completion of the user plane path switch, and the target network node 415 may communicate with the source network node 410 to release a context associated with the UE 405 at the source network node 410.

As indicated above, FIG. 4 is provided as an example. Other examples may differ from what is described with regard to FIG. 4.

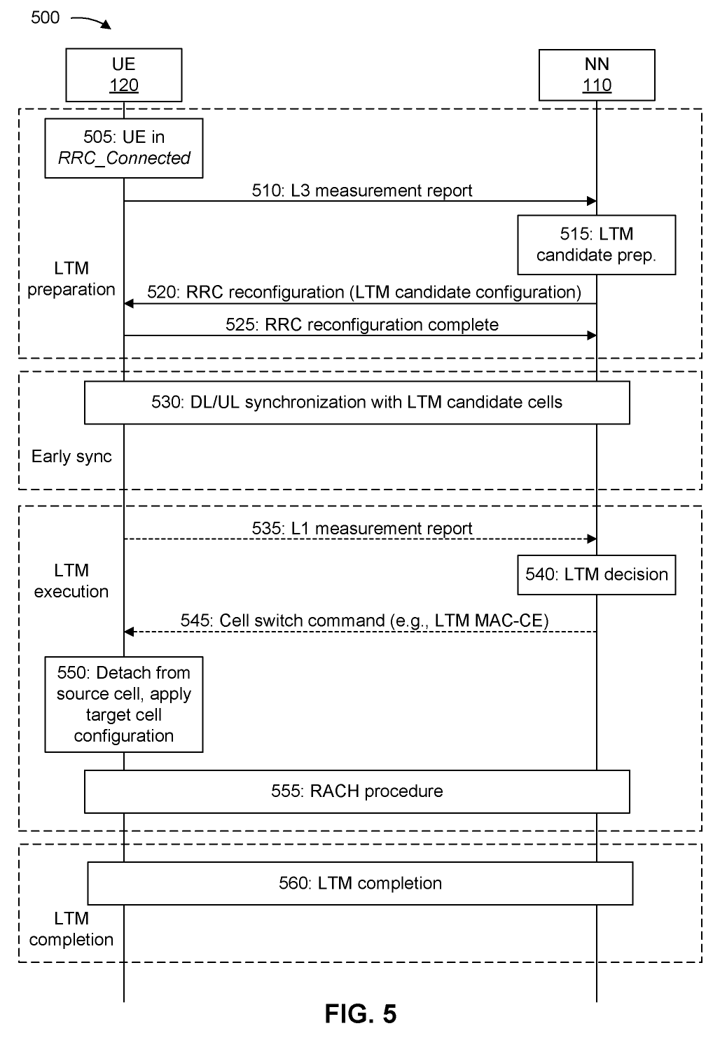

FIG. 5 is a diagram illustrating an example 500 of an LTM procedure, in accordance with the present disclosure. As shown in FIG. 5, example 500 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink.

In some examples, the network node 110 may instruct the UE 120 to change or switch serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using an L3 handover procedure, such as the L3 handover procedure shown in FIG. 3, which may be referred to herein as a legacy handover procedure. In an L3 handover procedure, the network node 110 may transmit, to the UE 120, an RRC reconfiguration message indicating that the UE 120 is to perform a handover procedure to a target cell. For example, the network node 110 may transmit the reconfiguration message triggering the handover to the target cell in response to the UE 120 providing the network node 110 with an L3 measurement report indicating signal strength measurements associated with one or more cells (e.g., measurements associated with the source cell and/or one or more neighboring cells). In response to the RRC reconfiguration message, the UE 120 may communicate with the source cell and the target cell to detach from the source cell and connect to the target cell (e.g., the UE 120 may perform a contention-free RACH procedure in the target cell to establish an RRC connection with the target cell in accordance with a contention-free random access (CFRA) configuration indicated in the RRC reconfiguration message). Once handover is complete, the target cell may communicate with a UPF of a core network to instruct the UPF to switch a user plane path of the UE 120 from the source cell to the target cell. The target cell may also communicate with the source cell to indicate that handover is complete and that the source cell may be released.

As described herein, L3 handover procedures may be associated with high latency and high overhead due to the multiple RRC reconfiguration messages and/or other L3 signaling and operations used to perform the handover procedures. Accordingly, in some examples, a UE 120 may be configured to perform an LTM procedure, such as the LTM procedure shown in FIG. 5, which uses L1/L2 signaling to significantly reduce a handover latency relative to a legacy L3 handover procedure. For example, as shown in FIG. 5, the LTM procedure may include an LTM preparation phase, an early synchronization phase (shown as “early sync” in FIG. 5), an LTM execution phase, and an LTM completion phase.

As shown by reference number 505, during the LTM preparation phase, the UE 120 may be in an RRC connected state (sometimes referred to as RRC_Connected) with a source cell provided by the network node 110. As shown by reference number 510, the UE 120 may transmit, and the network node 110 may receive, an L3 measurement report (sometimes referred to as a MeasurementReport), which may indicate measurements related to a signal strength (e.g., RSRP measurements, RSSI measurements, RSRQ measurements, and/or CQI values) or other suitable measurements associated with the source cell and/or one or more neighboring cells. In some examples, based at least in part on the L3 measurement report or other information, the network node 110 may configure LTM for UE 120. Accordingly, as shown by reference number 515, the network node 110 may perform LTM candidate preparation. For example, during the LTM candidate preparation, the network node 110 may obtain configuration information for one or more LTM candidate cells (e.g., one or more parameters related to an identity for each LTM candidate cell, a synchronization and/or measurement configuration for each LTM candidate cell, and/or a full RRC configuration message associated with each LTM candidate cell, among other examples).

As shown by reference number 520, the network node 110 may transmit, and the UE 120 may receive, an RRC reconfiguration message (sometimes referred to as an RRCReconfiguration message), which may include an LTM configuration. More particularly, the LTM configuration included in the RRC reconfiguration message may indicate the configuration information for one or more LTM candidate cells (e.g., obtained during the LTM candidate preparation), which may be candidate cells to become a serving cell of the UE 120 and/or cells for which the UE 120 may later be triggered to perform an LTM procedure. As shown by reference number 525, the UE 120 may store the configuration information for the one or more LTM candidate cells and may transmit, in response to the RRC reconfiguration message, an RRC reconfiguration complete message (sometimes referred to as an RRCReconfigurationComplete message) to the network node 110.

As shown by reference number 530, during the early synchronization phase, the UE 120 may optionally perform downlink synchronization and/or uplink synchronization with the LTM candidate cells associated with the one or more LTM candidate cell configurations. For example, the UE 120 may perform downlink synchronization and timing advance acquisition with the one or more LTM candidate cells prior to receiving an LTM cell switch command. In some aspects, performing the early synchronization with the one or more candidate cells may reduce latency associated with performing a RACH procedure later in the LTM procedure, which is described in more detail below in connection with reference number 555. For example, the UE 120 may acquire the timing advance for an LTM candidate cell in accordance with a measured timing advance indicated in the configuration information for the LTM candidate cell and/or by using PRACH transmission parameters indicated in the configuration information (e.g., in an early synchronization configuration, which may be provided in an EarlyUL-SyncConfig parameter) to transmit a PRACH to the LTM candidate cell.

As shown by reference number 535, during the LTM execution phase, the UE 120 may obtain L1 measurements associated with the configured LTM candidate cells, and may transmit, to the network node 110, one or more L1 measurement reports associated with the configured LTM candidate cells. As shown by reference number 540, based at least in part on the L1 measurement report(s), the network node 110 may decide to execute an LTM cell switch to an LTM target cell (e.g., included among the configured LTM candidate cells). Accordingly, as shown by reference number 545, the network node 110 may transmit, and the UE 120 may receive, a MAC-CE or another suitable L1 or L2 message triggering an LTM cell switch (e.g., the message triggering the LTM cell switch may be referred to herein as a cell switch command, an LTM cell switch command MAC-CE, a MAC-CE carrying a cell switch command, or the like). The cell switch command may indicate a candidate configuration index associated with the LTM target cell. As shown by reference number 550, based at least in part on the cell switch command, the UE 120 may switch to the configuration of the LTM target cell (e.g., the UE 120 may detach from the source cell and apply the configuration of the LTM target cell). Moreover, as shown by reference number 555, the UE 120 may perform a RACH procedure towards the LTM target cell, such as when a timing advance associated with the target cell is not available (e.g., in cases in which the UE 120 did not perform the early synchronization described above in connection with reference number 530 and/or the LTM cell switch command does not indicate a valid timing advance for the LTM target cell).

As shown by reference number 560, during the LTM completion phase, the UE 120 may indicate successful completion of the LTM cell switch towards the LTM target cell. In this way, a cell switch or handover to a target cell may be performed using L1/L2 signaling, which is associated with less overhead than an L3 handover procedure and/or a reduced latency relative to an L3 handover procedure.

As indicated above, FIG. 5 is provided as an example. Other examples may differ from what is described with regard to FIG. 5.

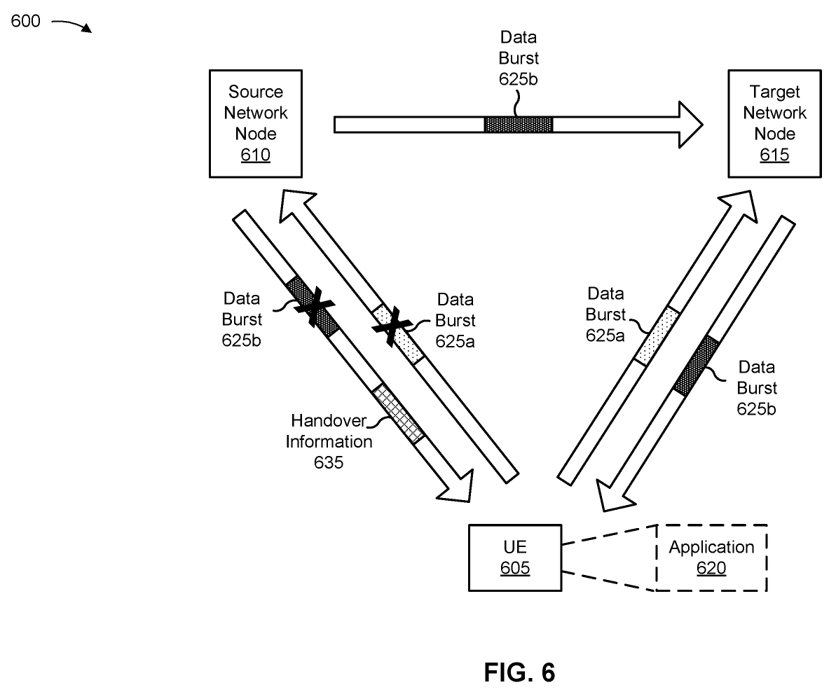

FIG. 6 is a diagram illustrating an example 600 associated with a UE 605 performing a handover procedure without considering a data burst interval, in accordance with the present disclosure. In some cases, example 600 may implement or may be implemented by one or more aspects of wireless communication network 100, network node architecture 200, example 300, example 400, or example 500. As shown in FIG. 6, example 600 includes a UE 605, which may correspond to the UE 120 described elsewhere herein. Additionally, a source network node 610 may correspond to the network node 110 described elsewhere herein (such as the source network node 310 or the source network node 410). Additionally, a target network node 615 may correspond to the network node 110 described elsewhere herein (such as the target network node 315 or the target network node 415).

As shown in FIG. 6, the UE 605 and the source network node 610 may communicate via a wireless link. In some examples, the wireless link may be associated with a wireless wide area network (WWAN) RAT. For example, the wireless link may be a wireless access link that may facilitate uplink and/or downlink communications between the UE 605 and the source network node 610.

In some examples, the UE 605 and the source network node 610 may communicate one or more data bursts 625. For example, a data burst 625 may refer to a short period of time during which a large volume of data is transmitted in rapid succession (e.g., a volume of data that satisfies a threshold over a duration of time that satisfies a threshold). Additionally, the data bursts 625 may be followed by periods of lower data transmission or inactivity. In some examples, the data bursts 625 can occur in both the uplink direction (e.g., from the UE 605 to the source network node 610) and the downlink direction (e.g., from the source network node 610 to the UE 605), depending on a type of application and/or one or more characteristics associated with the data exchange.

In accordance with the uplink direction, data bursts 625 may occur if the UE 605 transmits an amount of data to the network node that satisfies a threshold and transmits over a duration that satisfies a threshold (e.g., a relatively large amount of data over a relatively short duration of time). Such data bursts 625 might be triggered by user actions, such as uploading a video or sending a large file. Therefore, the source network node 610 may allocate sufficient resources to handle data bursts 625 transmitted by the UE 605, ensuring that the data is transmitted in accordance with a low latency metric while reducing a likelihood of packet loss.

In accordance with the downlink direction, data bursts 625 may occur if the source network node 610 transmits an amount of data to the UE 605 that satisfies a threshold and transmits over a duration that satisfies a threshold (e.g., a relatively large amount of data over a relatively short duration of time). For example, the data included in the data bursts 625 may be associated with streaming video or XR. Therefore, the source network node 610 may increase the allocation of wireless resources in accordance with transmitting a data burst 625 to ensure that the UE 605 receives the data smoothly. That is, the source network node 610 may operate in accordance with one or more buffering, resource scheduling, and/or other mechanisms to handle the data bursts 625 while maintaining a quality of service that satisfies a threshold.

In some examples, data burst intervals may refer to respective durations of time between consecutive data bursts 625. Such data burst intervals can vary based on the type of data included in the data bursts 625 and/or network conditions. For instance, a video streaming service may generate bursts at regular and/or periodic intervals as video segments are buffered, while a real-time game may produce irregular bursts based on in-game events or player actions. Therefore, the source network node 610 may analyze one or more characteristics associated with the data burst intervals to allocate resources efficiently and provide a seamless playback of the data included in the data bursts 625. The one or more characteristics associated with the data burst intervals may include a data burst interval occurrence and/or a data burst interval duration. In some examples, the source network node 610 may analyze the one or more characteristics to predict subsequent data burst intervals (e.g., in accordance with one or more AI/ML models). Additionally, or alternatively, the UE 605 may analyze the one or more characteristics to predict subsequent data burst intervals (e.g., in accordance with one or more AI/ML models).

In some examples, the data bursts 625 (e.g., in the uplink and/or downlink direction) may be associated with an application 620 operating at the UE 605. In some examples, the periodicity and/or size of the data bursts 625 may be based on the application 620 and/or data parameters associated with the application 620.

In some examples, the application 620 may be associated with XR information. For example, XR, which includes virtual reality (VR) and/or augmented reality (AR), may be associated with high data throughputs (e.g., data throughputs that satisfy a threshold). Such applications may generate data bursts 625 in both the uplink and downlink directions. For example, in a VR experience, the source network node 610 may transmit, to the UE 605, large amounts of data (such as high-resolution images and three-dimensional (3D) models) to render immersive environments. Additionally, in the uplink downlink direction, the UE 605 may transmit, to the source network node 610, data bursts 625 that include user movements and/or sensor data for real-time processing and rendering.

In some examples, the application 620 may be associated with AR. For example, AR applications may overlay digital content onto the real world, in accordance with user interactions and/or changes in the environment. Therefore, the UE 605 may transmit to the source network node 610 data bursts 625 to send video and/or sensor information for processing at the source network node 610. Additionally, the source network node 610 may transmit, to the UE 605, a data burst 625 to send updated overlays or instructions back to the UE 605.

In some examples, the application 620 may be associated with video games. For example, real-time multiplayer video games may be associated with high levels of data bursts 625. The UE 605 may transmit, to the source network node 610, data bursts 625 to send information associated with player actions (such as movement and/or communication with other players). The UE 605 may transmit the data bursts 625 in accordance with a low latency metric to increase responsiveness of gameplay. Additionally, the source network node 610 may transmit, to the UE 605, data bursts 625 that indicates updates from other players, changes to the game environment, and/or graphical information associated with the video game.

In some examples, the application 620 may be associated with video streaming. For example, the source network node 610 may transmit to the UE 605 data bursts 625 that includes information associated with multiple frames of a video (such as multiple seconds of video content per data burst 625). In some examples, the UE 605 may store the data bursts 625 in an associated buffer to account for receiving sequenced data out of order and/or fluctuations in network service quality to ensure smooth playback of the video stream.

In some examples, the application 620 may be associated with IoT applications. For example, the UE 605 may be an example of an IoT device, where the application 620 may generate data bursts 625 that include sensor and/or status updates associated with the application 620 (such as smart home devices, health monitors, or industrial sensors that collect data for transmission over configurated time intervals). Therefore, the UE 605 may transmit, to the source network node 610, data bursts 625 in accordance with IoT applications.

In some examples, the UE 605 may operate in accordance with a handover procedure. For example, the UE 605 may establish a wireless link with the target network node 615 and may release the wireless link with the source network node 610. In some examples, the wireless link between the UE 605 and the target network node 615 may be associated with a WWAN RAT. For example, the wireless link may be a cellular link that may facilitate uplink and/or downlink communications between the UE 605 and the target network node 615. In some examples, the UE 605 may perform the handover from the source network node 610 to the target network node 615 in accordance with one or more of the techniques of FIGS. 3-5. For example, the UE 605 may perform the handover to the target network node 615 in accordance with an L3 handover procedure, in accordance with a CHO procedure, or in accordance with an LTM procedure.

Additionally, the UE 605 may perform the handover in accordance with receiving, from the source network node 610, handover information 635. In some examples, the handover information 635 may be indicated via control signaling (e.g., an RRCReconfiguration message). For example, in accordance with L3 handover, the handover information 635 may be associated with reference number 355 (e.g., included in an RRCReconfiguration message, which may include a handover command). In accordance with CHO, the handover information 635 may be associated with reference number 450 (e.g., included in an RRCReconfiguration message, which may include a CHO configuration). In accordance with the LTM procedure the handover information 635 may be associated with reference number 520 (e.g., included in an RRCReconfiguration message, which may include an LTM configuration). Therefore, the UE 605 may perform the handover procedure in accordance with the handover information 635.

In some examples, the handover procedure may be a sequence handover. For example, as part of the handover information 635, the source network node 610 may indicate a set of target network node 615s that the UE 605 may attempt to perform the handover with. As such, if the UE 605 fails to establish a wireless link 620 with a first target network node 615 of the set of target network node 615s, the UE 605 may perform a subsequent handover procedure with a second target network node 615 of the set of target network nodes. Therefore, in accordance with the sequence handover, the UE 605 may attempt respective handover procedures with the set of target network nodes until the UE 605 successfully establishes a wireless link with one of the target network nodes. In accordance with the sequence handover, the UE 605 may attempt to establish a wireless link multiple times in accordance with a receiving the handover information 635. Therefore, a sequence handover may reduce signaling overhead between the UE 605 and the source network node 610.

In some examples, the handover procedure may be a non-sequence handover. For example, as part of the handover information 635, the source network node 610 may indicate a single target network node for the handover. Therefore, the UE 605 may perform handover with the single target network node indicated in the handover information 635. If the UE 605 is unable to establish a wireless link with the single target network node 615, then the UE 605 may transmit, and the source network node 610 may receive, a feedback communication associated with the unsuccessful handover. In some examples, the feedback communication may indicate a cause for the unsuccessful handover (e.g., one or more of signal quality that does not satisfy a threshold, insufficient resources associated with the target network node 615, handover timing issues, a radio link failure (RLF) indication, interference of neighboring network nodes, handover parameter misconfiguration, or mobility of the UE 605). In accordance with the cause of the unsuccessful handover, the source network node 610 may determine another target network node for the UE 605 to handover to, and transmit to the UE 605 an indication of the determined target network node. Therefore, the UE 605 may attempt to handover to the determined target network node 615. In accordance with the non-sequence handover, the UE 605 and the source network node 610 may communicate and adapt to the conditions of the wireless environment, which may reduce latency for handover in wireless networks associated with rapidly changing wireless conditions.

In some examples, the handover of the UE 605 from the source network node 610 to the target network node 615 may occur while the application 620 is operating at the UE 605. For instance, in example 600, the UE 605 may be prepared and/or scheduled to transmit to the source network node 610 a data burst 625a that is associated with operations of the application 620. Additionally, or alternatively, the source network node 610 may be prepared and/or scheduled to transmit to the UE 605 a data burst 625b that is associated with operations of the application 620. In some cases, however, and in accordance with the handover information 635, the UE 605 may perform handover to the target network node 615 before transmission of the data burst 625a and/or the data burst 625b. For example, if the handover information 635 indicates a handover command (e.g., an L3 handover command or an LTM command) or if the handover information 635 configures conditional handover and the UE 605 identifies that one or more conditions for handover are satisfied, then the UE 605 may delay communication of data burst 625a and/or data burst 625b and perform the handover procedure. In such an example, the UE 605 and the source network node 610 may not communicate the data burst 625a and/or the data burst 625b. Rather, the UE 605 may communicate the data burst 625a and/or the data burst 625b with the target network node 615 after competition of the handover procedure. Therefore, the handover procedure may cause data interruption during which the UE 605 may not transmit or receive any data bursts 625 associated with the application 620 from the source network node 610 or the target network node 615. In other words, example 600 may illustrate a handover without the UE 605 and/or the source network node 610 considering data burst intervals.

By not considering data burst intervals while preforming handover, one or more data bursts 625 associated with application 620 may be delayed. In examples where the data associated with application 620 is delay-sensitive (e.g., XR data, video streaming data, video game data, or IoT data), delaying communication of the data bursts 625 may reduce performance of the application 620. In some examples, the delay may cause buffer underflows and/or overflows. For example, the UE 605 may be associated with one or more buffers to handle incoming and outgoing data streams. For delay-sensitive applications, the one or more buffers may be designed to store a threshold quantity of data to compensate for minor network jitter or transmission delays.

Therefore, based on excessive delays in receiving data, the UE 605 may experience buffer underflows, where there is insufficient data to maintain continuous playback or processing. Conversely, if the handover delay results in the UE 605 receiving multiple data bursts 625 within a shorter duration than the anticipated data burst interval, the one or more buffers may overflow, which may result in the UE 605 discarding excess data and/or may reduce memory management operations, potentially disrupting ongoing processes at the application 620. Additionally, or alternatively, the data burst 625 delays may result in resource allocation challenges. For example, the UE 605 may allocate resources (such as processing power, memory, and network bandwidth) to maintain smooth operation of data. Therefore, delays in data may result in the UE 605 reallocating the resources, which may disrupt efficient functioning of the UE 605. Additionally, or alternatively, the delay in data bursts 625 may increase network overhead. For instance, in example 600 the source network node 610 may send and the target network node 615 may receive the data burst 625b based on the handover occurring before the source network node 610 could transmit the data burst 625b. Therefore, the source network node 610 and target network node 615 may allocate resources to forward the data burst 625b to the target network node 615, which may increase network overhead.

Various aspects of the present disclosure may increase data burst interval awareness of handover procedures at the source network node 610 and/or the UE 605. For example, the source network node 610 may transmit, and the UE 605 may receive, an indication of one or more handover delay rules to determine whether to delay handover in accordance with a data burst interval. In accordance with the one or more handover delay rules the UE 605 and/or source network node 610 may determine whether to transmit one or more data bursts 625 (via uplink and/or downlink) before or after a handover procedure.

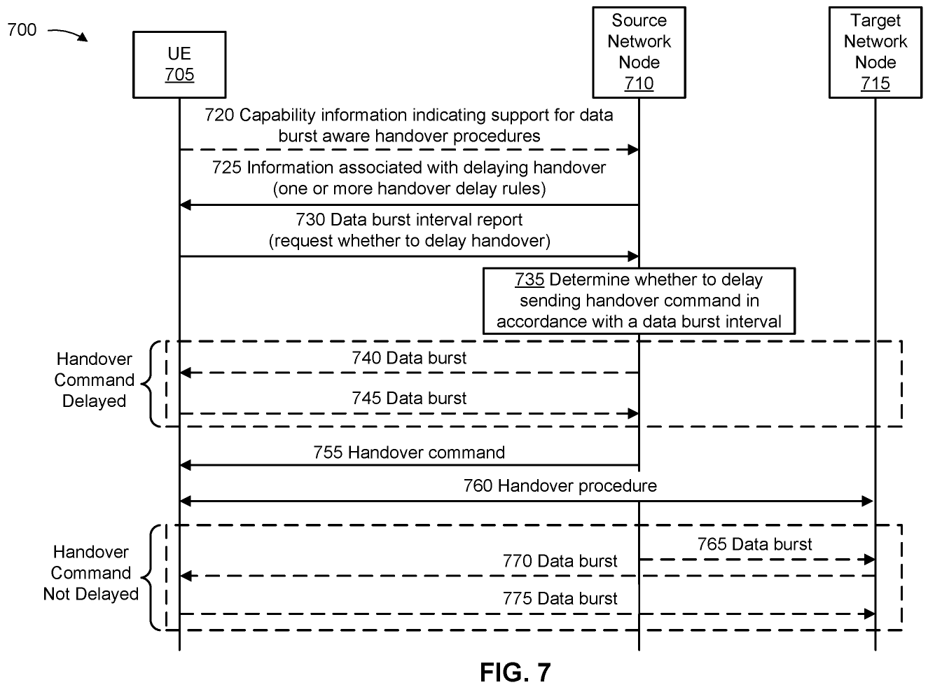

In cases of a handover triggered by a network handover command (e.g., an L3 handover command or an LTM cell switch command), the UE 605 may transmit a burst interval report that indicates a request for the source network node 610 to delay transmission of a handover command. In accordance with the burst interval report and/or a predicted arrival time for the UE 605 to receive a data burst 625 via downlink, the source network node 610 may determine whether to communicate one or more data bursts 625 before or after transmitting the handover command. Further description of handover delay determination for handovers triggered by a network handover command is provided herein, including with reference to FIG. 7.

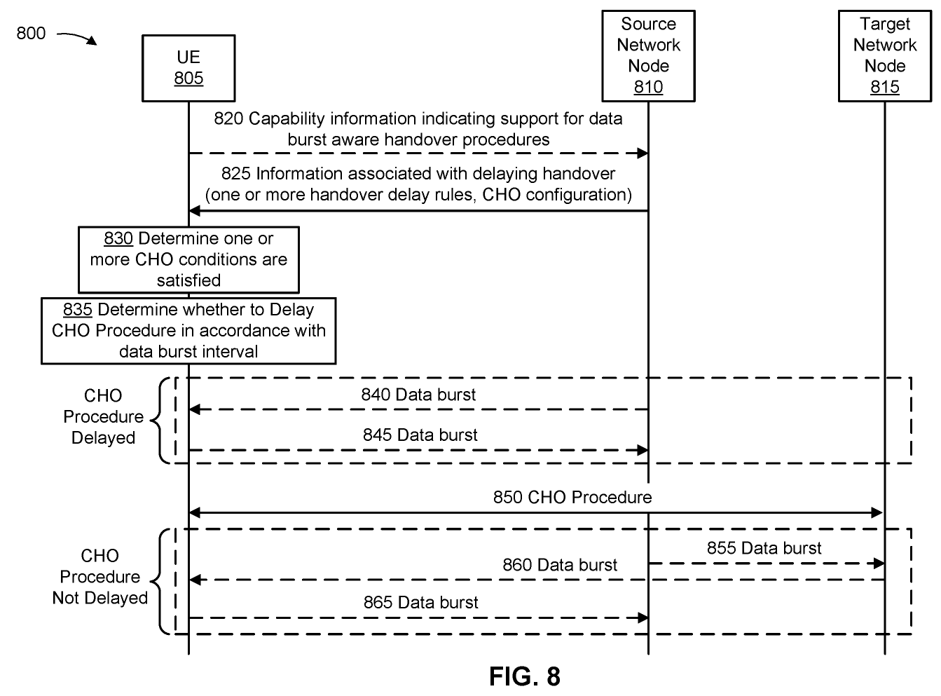

In cases of a handover triggered based on the UE 605 identifying that one or more handover conditions are satisfied (e.g., a CHO procedure), the UE 605 may use the one or more handover delay rules to determine whether to delay the conditional handover in accordance with communication of one or more data bursts 625. Further description of handover delay determination by the UE 605 for CHO procedures is provided herein, including with reference to FIG. 8.

As indicated above, FIG. 6 is provided as an example. Other examples may differ from what is described with regard to FIG. 6.

FIG. 7 is a diagram illustrating an example 700 associated with data burst awareness for handover procedures initiated by a command, in accordance with the present disclosure. Example 700 may implement or be implemented by one or more aspects of wireless communication network 100, network node architecture 200, example 300, or example 500. For instance, example 700 includes wireless communications between a UE 705, a source network node 710, and a target network node 715. In some examples, the UE 705 may correspond to the UE 120 described elsewhere herein. Additionally, the source network node710 may correspond to the network node 110 described elsewhere herein (such as source network node 310). Additionally, the target network node 715 may correspond to the network node 110 described elsewhere herein (such as target network node 315). Alternative examples of the following may be implemented, where some operations are performed in a different order than described, or not described at all. In some cases, one or more operations may include additional features not mentioned below, or further operations may be added. In addition, while example 700 shows operations between the UE 120 and one or more network nodes 110, the communication may occur between any number of network devices of various types described herein.

In a first operation 720, the UE 705 may transmit, and the source network node 710 may receive, capability information. For example, the capability information may indicate support for data burst aware handover procedures. That is, the capability information may indicate that the UE 705 is capable of delaying handover to communicate one or more data bursts (e.g., data burst 625) with the source network node 710 before handover to the target network node 715.

In a second operation 725, the source network node 710 may transmit, and the UE 705 may receive, information associated with delaying handover. For example, the information may indicate one or more handover delay rules, where the handover delay rules may be associated with determining whether to delay a handover procedure. In some examples, the source network node 710 may transmit the information associated with delaying handover in accordance with the capability information. In some examples, the source network node 710 may transmit information associated with handover via RRC signaling (e.g., via an RRCReconfiguration message).

In some cases, the one or more handover delay rules may be associated with the measurement associated with the source network node 710. For example, the one or more handover delay rules may include one or more thresholds associated with a quality metric for communications with the source network node 710 (e.g., measured by the UE 705). For example, the one or more thresholds may include one or more of a threshold associated with an RSRP measurement, a threshold associated with an RSRQ measurement, a threshold associated with an RSSI measurement, or a threshold associated with a SINR measurement.

Additionally, or alternatively, the one or more handover rules may include one or more thresholds associated with a source network node 710 scheduling rate. For example, the one or more thresholds may include one or more of a threshold associated with an uplink scheduling rate associated with uplink data bursts transmitted by the UE 705, a threshold associated with a downlink scheduling rate associated with downlink data bursts transmitted by the source network node 710, or a threshold associated with a total scheduling rate associated with uplink data bursts transmitted by the UE 705 and downlink data bursts transmitted by the source network node 710.

Additionally, or alternatively, the one or more handover delay rules may be associated with a predicted arrival time of a data burst (e.g., predicted uplink data packet arrival time and/or predicted downlink data packet arrival time). For example, the one or more handover delay rules may indicate a threshold (e.g., a configured duration) associated with predicted packet arrival. In some examples, the one or more handover rules may include respective thresholds (e.g., respective durations) associated with the predicted uplink data packet arrival time and the predicted downlink data packet arrival time.

In some examples, the UE 705 may determine the predicted uplink data packet arrival time at the source network node 710 based on one or more uplink conditions.

For instance, the one or more uplink conditions may include one or more of an arrival time of an uplink data packet for arrival at a buffer of the UE 705, a frequency and/or periodicity associated with previous uplink data bursts, a duration for the UE 705 to generate and/or encode one or more data packets for an uplink data burst to the source network node 710, a wireless transmission delay associated with transmitting via uplink to the source network node 710, or a channel quality associated with the wireless link between the source network node 710 and the UE 705. In some examples, the UE 705 may determine a predicted downlink data packet arrival time from the source network node 710 based on one or more downlink conditions. For instance, the one or more downlink data conditions may include one or more of an arrival time of a downlink data packet for arrival at a buffer of the UE 705, a frequency and/or periodicity associated with previous downlink data bursts, a scheduling rate of downlink data packets for transmission to the UE 705 (e.g., a DCI scheduling rate), a wireless transmission delay associated with receiving via downlink from the source network node 710, or a channel quality associated with the wireless link between the source network node 710 and the UE 705. Additionally, or alternatively, the UE 705 may determine the predicted uplink data packet arrival time and/or the predicted downlink data packet arrival time in accordance with one or more AI/ML models.

In some examples, the source network node 710 may determine the predicted uplink data packet arrival time at the source network node 710 based on one or more uplink conditions. For instance, the one or more uplink conditions may include one or more of a frequency and/or periodicity associated with previous uplink data bursts from the UE 705, a wireless transmission delay associated with receiving data packets from the UE 705 via uplink, or a channel quality associated with the wireless link between the source network node 710 and the UE 705. In some examples, the source network node 710 may determine a predicted downlink data packet arrival time from the source network node 710 based on one or more downlink conditions. For instance, the one or more downlink data conditions may include one or more of a duration for the source network node 710 to generate and/or encode one or more data packets for a downlink data burst to the source network node 710, a wireless transmission delay associated with transmitting via downlink to the UE 705, or a channel quality associated with the wireless link between the source network node 710 and the UE 705. Additionally, or alternatively, the source network node 710 may determine the predicted uplink data packet arrival time and/or the predicted downlink data packet arrival time in accordance with one or more AI/ML models.

Additionally, or alternatively, the one or more handover delay rules may indicate for the UE 705 to generate a measurement report. For example, the measurement report may include measuring one or more signals associated with communications with the source network node 710. For example, the one or more quality metrics may include one or more of an RSRP value, an RSRQ value, an RSSI value, or an SINR value. In some examples, the measurement report may be associated with reference number 345 (e.g., a measurement report associated with the L3 handover procedure). In some examples, the measurement report may be associated reference number 510 (e.g., the L3 measurement report sometimes referred to as the MeasurementReport) and/or with reference number 535 (e.g., the L1 measurement report). In some examples, the one or more handover delay rules may indicate for the UE 705 to include the measurement report in a data burst interval report (e.g., associated with a third operation 730).

Additionally, or alternatively, the one or more handover delay rules may be associated with a duration for delaying the handover procedure. For example, the one or more handover rules may indicate a threshold associated with delaying the handover procedure (e.g., a maximum duration the handover procedure may be delayed). In some examples, the one or more handover delay rules may indicate respective thresholds associated with delaying the handover procedure for the respective types of handover associated with network initiated handover commands (e.g., an L3 handover procedure or LTM procedure).

In some examples, the one or more handover delay rules may include an expected handover execution. For example, in accordance with the L3 handover procedure, the information may indicate that the source network node 710 is expecting to transmit an L3 handover command to the UE 705 to initiate a handover to the target network node 715. In accordance with the LTM procedure, the information may be associated with reference number 520 (e.g., indicate LTM candidate information), which may configure the UE 705 for a possible LTM procedure. In some examples, as part of indicating the expected handover execution, the source network node 710 may indicate a predicted time at which the source network node 710 may transmit the handover command (e.g., an L3 handover command associated with the L3 handover procedure or a cell switch command associated with the LTM procedure).

In a third operation 730, the UE 705 may transmit, and the source network node 710, may receive a data burst interval report. For example, the data burst interval report may indicate information associated with characteristics of data bursts generated by an application running on the UE 705 (e.g., the application 620). The information included in the data burst interval report may include one or more of burst timing information (e.g., timestamps indicating when each data burst starts and ends and/or a duration of each burst interval), a periodicity of the data bursts (e.g., how often data bursts occur and/or whether the data bursts occur at regular intervals or are triggered by specific events), data volume information (e.g., total amount of data transmitted during one or more data bursts), or a quality metric (e.g., a latency tolerance associated with the application 620 and/or a priority value associated with one or more data bursts).

Additionally, the data burst interval report may indicate the measurement report generated by the UE 705 in accordance with the one or more handover rules. For example, the measurement report may include the one or more quality metrics associated with the source network node 710, including one or more of an RSRP value, an RSRQ value, an RSSI value, or an SINR value.

In some aspects, the data burst interval report may indicate a duration associated with delaying a handover command (e.g., a holding time duration). For example, the duration may be a preferred duration by the UE 705 to delay the source network node 710 from transmitting a handover command. In some examples, the duration may be based on the predicted uplink data packet arrival time and/or predicted downlink data packet arrival time determined by the UE 705. In some examples, the duration may be based on the threshold associated with delaying the handover procedure (e.g., as included in the one or more handover delay rules).

In a fourth operation 735, the source network node 710 may determine to whether to delay sending the handover command in accordance with a data burst interval.

In some examples, the determination of whether to delay sending the handover command may be based on the predicted downlink packet arrival time (e.g., as determined by the source network node 710). For example, the source network node 710 may compare the predicted downlink packet arrival time to the threshold included in the one or more handover delay rules associated with the predicted downlink packet arrival time (e.g., a first threshold), compare a quality metric included in the measurement report to the threshold associated with the quality metric included in the one or more handover delay rules (e.g., a second threshold), and compare the source network node 710 scheduling rate to the threshold associated with the source network node 710 scheduling rate (e.g., a third threshold). If the predicted downlink packet arrival time does not satisfy the first threshold (e.g., is greater than or equal to the first threshold), the quality metric does not satisfy the second threshold (e.g., is less than or equal to the second threshold), or the source network node scheduling rate does not satisfy the third threshold (e.g., is less than or equal to the third threshold), then source network node 710 may refrain from delaying the handover command (e.g., handover command is not delayed). In other words, the handover is not delayed if the predicted downlink data packet arrival time is large, because the handover might be complete (or there may be minimal data interruption) by the time the downlink data burst arrives, if the signal quality is poor because the downlink data burst transmission may not be reliable, which may lead to retransmission, or if the scheduling rate is low which may mean that the downlink data bursts have a lower periodicity. If the predicted downlink packet arrival time satisfies the first threshold (e.g., is less than or equal to the first threshold) or the quality metric satisfies the second threshold (e.g., is greater than or equal to the second threshold), or the source network node scheduling rate satisfies the third threshold (e.g., is greater than or equal to the third threshold), then the source network node 710 may delay the handover command (e.g., handover command is delayed). In other words, the handover is delayed if the predicted downlink data packet arrival time is small, because the data may arrive before handover is complete, if the signal quality is high because the downlink data burst transmission may be reliable, or if the scheduling rate is high which may mean that the downlink data bursts have a higher periodicity.

In some examples, the determination of whether to delay sending the handover command may be based on the information included in the data burst interval report. For example, the source network node 710 may determine a predicted uplink packet time of arrival based on the information associated with the data burst interval, based on a quality metric included in the measurement report, and/or based on the source network node 710 scheduling rate. In some examples, the source network node 710 may compare the predicted uplink packet arrival time to the threshold included in the one or more handover delay rules associated with the predicted uplink packet arrival time (e.g., a first threshold), compare the quality metric to the threshold associated with the quality metric included in the one or more handover delay rules (e.g., a second threshold), and compare the compare the source network node 710 scheduling rate to the threshold associated with the source network node 710 scheduling rate (e.g., a third threshold). If the predicted uplink packet arrival time does not satisfy the first threshold (e.g., is greater than or equal to the first threshold), the quality metric does not satisfy the second threshold (e.g., is less than or equal to the second threshold), or the source network node scheduling rate does not satisfy the third threshold (e.g., is less than or equal to the third threshold), then source network node 710 may refrain from delaying the handover command (e.g., handover command is not delayed). In other words, the handover is not delayed if the predicted uplink data packet arrival time is large, because the handover might be complete (or there may be minimal data interruption) by the time the uplink data burst arrives, if the signal quality is poor because the uplink data burst transmission may not be reliable, which may lead to retransmission, or if the scheduling rate is low which may mean that the uplink data bursts have a lower periodicity. If the predicted uplink packet arrival time satisfies the first threshold (e.g., is less than or equal to the first time threshold), the quality metric satisfies the second threshold (e.g., is greater than or equal to the second threshold), and/or the source network node scheduling rate does not satisfy the third threshold (e.g., is less than or equal to the third threshold), then the source network node 710 may delay the handover command (e.g., handover command is delayed). In other words, the handover is delayed if the predicted uplink data packet arrival time is small, because the data may arrive before handover is complete, if the signal quality is high because the uplink data burst transmission may be reliable, or if the scheduling rate is high which may mean that the uplink data bursts have a higher periodicity.

If the source network node 710 determines to delay the handover command in accordance with the fourth operation 735, then the UE 705 and/or the source network node 710 may perform a fifth operation 740 and/or a sixth operation 745 in which one or more uplink and/or downlink bursts are transmitted before transmission of the handover command.

In the fifth operation 740, the source network node 710 may transmit, and the UE 705 may receive, a downlink data burst before the source network node 710 transmits the handover command. In some examples, the UE 705 may transmit, and the source network node 710 may receive, a feedback communication indicating successful reception of the downlink data burst at the UE 705. In some examples, the source network node 710 may transmit the handover command in accordance with receiving the feedback communication and if there is no data for the UE 705 in a buffer of the source network node 710 or if a duration associated with delaying the handover expires.

In the sixth operation 745, the UE 705 may transmit, and the source network node 710 may receive, an uplink data burst before the source network node 710 transmits the handover command.

In a seventh operation 755, the source network node 710 may transmit, and the UE 705 may receive, the handover command. For example, the handover command may be an L3 handover command associated with the L3 handover procedure or may be a cell switch command associated with the LTM procedure.

In an eighth operation 760, the UE 705 and the target network node 715 may perform the handover procedure in accordance with the handover command in the seventh operation 755. For example, the handover procedure may be performed in accordance with one or more aspects of example 300 if the handover command is associated with the L3 handover procedure or the handover procedure may be performed in accordance with one or more aspect of the example 500 if the handover command is associated with the LTM procedure.

If the source network node 710 determines to delay the handover command in accordance with the fourth operation 735, then the UE 705, the source network node 710, and/or the target network node 715 may perform a ninth operation 765, a tenth operation 770, and/or an eleventh operation 775 in which one or more uplink and/or downlink bursts are transmitted after transmission of the handover command and performing the handover procedure.

In the ninth operation 765, the source network node 710 sends, and the target network node 715 receives, the downlink data burst. For example, the downlink data burst may be the same downlink data burst described in the fifth operation 740, however, the downlink data burst is forwarded to the target network node 715 based on not delaying the handover command. Alternatively, the source network node 710 may perform the ninth operation 765 based on receiving a NACK or not receiving an ACK from the UE for a data burst transmitted before the handover command, or based on the maximum handover delay time expiring.

In a tenth operation 770, the target network node 715 may transmit, and the UE 705 may receive, the downlink data burst. In other words, the UE 705 receives the downlink data burst from the target network node 715 based on the source network node 710 not delaying the handover command. In some examples, the ninth operation 765 and the tenth operation 770 may be operations that are alternative to the fifth operation 740.

In an eleventh operation 775, the UE 705 may transmit, and the target network node 715 may receive, the uplink data burst. For example, the uplink data burst may be the same uplink data burst described in the sixth operation 745, however the UE 705 transmits the uplink data burst to the target network node 715 based on the source network node 710 not delaying the handover command. In some examples, the eleventh operation 775 may be alternative to the sixth operation 745.

As indicated above, FIG. 7 is provided as an example. Other examples may differ from what is described with regard to FIG. 7.

FIG. 8 is a diagram illustrating an example 800 associated with data burst awareness for CHO procedures, in accordance with the present disclosure. Example 800 may implement or be implemented by one or more aspects of wireless communication network 100, network node architecture 200, or example 400. For instance, example 800 includes wireless communications between a UE 805, a source network node 810, and a target network node 815. In some examples, the UE 805 may correspond to the UE 120 described elsewhere herein. Additionally, the source network node 810 may correspond to the network node 110 described elsewhere herein (such as source network node 410). Additionally, the target network node 815 may correspond to the network node 110 described elsewhere herein (such as target network node 415). Alternative examples of the following may be implemented, where some operations are performed in a different order than described, or not described at all. In some cases, one or more operations may include additional features not mentioned below, or further operations may be added. In addition, while example 800 shows operations between the UE 120 and one or more network nodes 110, the communication may occur between any number of network devices of various types described herein.

In a first operation 820, the UE 805 may transmit, and the source network node 810 may receive, capability information. For example, the capability information may indicate support for data burst aware CHO procedures. That is, the capability information may indicate that the UE 805 is capable of delaying handover to communicate one or more data bursts (e.g., data burst 625) with the source network node 810 before handover to the target network node 815.

In a second operation 825, the source network node 810 may transmit, and the UE 805 may receive, information associated with delaying handover. For example, the information may indicate one or more handover delay rules, where the handover delay rules may be associated with determining whether to delay a CHO procedure. In some examples, the source network node 810 may transmit the information associated with delaying the CHO in accordance with the capability information. In some examples, the source network node 810 may transmit information associated with handover via RRC signaling (e.g., via an RRCRecofiguration message). In some examples, the information associated with delaying handover may indicate the one or more CHO conditions (e.g., as part of the CHO configuration) for satisfying the CHO procedure as described with reference to example 400.

In some cases, the one or more handover delay rules may be associated with a measurement associated with the source network node 810. For example, the one or more handover delay rules may include one or more thresholds associated with a quality metric for communications with the source network node 810 (e.g., measured by the UE 805). For example, the one or more thresholds may include one or more of a threshold associated with an RSRP measurement, a threshold associated with an RSRQ measurement, a threshold associated with an RSSI measurement, or a threshold associated with a SINR measurement.

Additionally, or alternatively, the one or more handover delay rules may include one or more thresholds associated with a source network node 810 scheduling rate. For example, the one or more thresholds may include one or more of a threshold associated with an uplink scheduling rate associated with uplink data bursts transmitted by the UE 805, a threshold associated with a downlink scheduling rate associated with downlink data bursts transmitted by the source network node 810, or a threshold associated with a total scheduling rate associated with uplink data bursts transmitted by the UE 805 and downlink data bursts transmitted by the source network node 810.

Additionally, or alternatively, the one or more handover delay rules may be associated with a predicted arrival time of a data burst (e.g., predicted uplink data packet arrival time and/or predicted downlink data packet arrival time). For example, the one or more handover delay rules may indicate a threshold (e.g., a configured duration) associated with predicted packet arrival. In some examples, the one or more handover rules may include respective thresholds (e.g., respective durations) associated with the predicted uplink data packet arrival time and the predicted downlink data packet arrival time.

In some examples, the UE 805 may determine the predicted uplink data packet arrival time at the source network node 810 based on one or more uplink conditions. For instance, the one or more uplink conditions may include one or more of an arrival time of an uplink data packet for arrival at a buffer of the UE 805, a frequency and/or periodicity associated with previous uplink data bursts, a duration for the UE 805 to generate and/or encode one or more data packets for an uplink data burst to the source network node 810, a wireless transmission delay associated with transmitting via uplink to the source network node 810, or a channel quality associated with the wireless link between the source network node 810 and the UE 805. In some examples, the UE 805 may determine a predicted downlink data packet arrival time from the source network node 810 based on one or more downlink conditions. For instance, the one or more downlink data conditions may include one or more of an arrival time of a downlink data packet for arrival at a buffer of the UE 805, a frequency and/or periodicity associated with previous downlink data bursts, a scheduling rate of downlink data packets for transmission to the UE 805 (e.g., a DCI scheduling rate), a wireless transmission delay associated with receiving via downlink from the source network node 810, or a channel quality associated with the wireless link between the source network node 810 and the UE 805. Additionally, or alternatively, the UE 805 may determine the predicted uplink data packet arrival time and/or the predicted downlink data packet arrival time in accordance with one or more AI/ML models.

In some examples, the source network node 810 may determine the predicted uplink data packet arrival time at the source network node 810 based on one or more uplink conditions. For instance, the one or more uplink conditions may include a periodicity associated with previous uplink data bursts from the UE 805, a wireless transmission delay associated with receiving data packets from the UE 805 via uplink, or a channel quality associated with the wireless link between the source network node 810 and the UE 805. In some examples, the source network node 810 may determine a predicted downlink data packet arrival time from the source network node 810 based on one or more downlink conditions. For instance, the one or more downlink data conditions may include one or more of a duration for the source network node 810 to generate and/or encode one or more data packets for a downlink data burst to the source network node 810, a wireless transmission delay associated with transmitting via downlink to the UE 805, or a channel quality associated with the wireless link between the source network node 810 and the UE 805. Additionally, or alternatively, the source network node 810 may determine the predicted uplink data packet arrival time and/or the predicted downlink data packet arrival time in accordance with one or more AI/ML models.

Additionally, or alternatively, the one or more handover delay rules may be associated with a duration for delaying the CHO procedure. For example, the one or more handover rules may indicate a threshold associated with delaying the CHO procedure (e.g., a maximum duration the CHO procedure may be delayed).

In a third operation 830, the UE 805 may determine that the one or more CHO conditions are satisfied. For example, the third operation 830 may be associated with reference number 455 (e.g., evaluate the one or more CHO conditions indicated by the source network node 810) and associated with reference number 460 (e.g., determine that the one or more CHO conditions are satisfied).

In a fourth operation 835, the UE 805 may determine whether to delay the CHO procedure in accordance with a data burst interval.

In some examples, the determination of whether to delay CHO procedure may be based on the predicted downlink packet arrival time (e.g., as determined by the UE 805). For example, the UE 805 may compare the predicted downlink packet arrival time to the threshold included in the one or more handover delay rules associated with the predicted downlink packet arrival time (e.g., a first threshold), compare a quality metric associated the source network node 810 to the threshold associated with the quality metric included in the one or more handover delay rules (e.g., a second threshold), and compare a source network node 810 scheduling rate to the threshold associated with the source network node 810 scheduling rate indicated in the one or more handover delay rules (e.g., a third threshold). If the predicted downlink packet arrival time does not satisfy the first threshold (e.g., is greater than or equal to the first threshold), the quality metric does not satisfy the second threshold (e.g., is less than or equal to the second threshold), or the source network node 810 scheduling rate does not satisfy the third threshold (e.g., is less than or equal to the third threshold) then the UE 805 may refrain from delaying CHO procedure (e.g., CHO procedure is not delayed). In other words, the handover is not delayed if the predicted downlink data packet arrival time is large, because the handover might be complete (or there may be minimal data interruption) by the time the downlink data burst arrives, if the signal quality is poor because the downlink data burst transmission may not be reliable, which may lead to retransmission, or if the scheduling rate is low which may mean that the downlink data bursts have a lower periodicity. If the predicted downlink packet arrival time satisfies the first threshold (e.g., is less than or equal to the first threshold), the quality metric satisfies the second threshold (e.g., is greater than or equal to the second threshold), and the source network node 810 scheduling rate does not satisfies the third threshold (e.g., is greater than or equal to the third threshold) then the source network node 810 may not delay the CHO procedure (e.g., CHO procedure is delayed). In other words, the handover is delayed if the predicted downlink data packet arrival time is small, because the data may arrive before handover is complete, if the signal quality is high because the downlink data burst transmission may be reliable, or if the scheduling rate is high which may mean that the downlink data bursts have a higher periodicity.

In some examples, the determination of whether to delay CHO procedure may be based on the predicted uplink packet arrival time (e.g., as determined by the UE 805). For example, the UE 805 may compare the predicted uplink packet arrival time to the threshold included in the one or more handover delay rules associated with the predicted uplink packet arrival time (e.g., a first threshold), compare a quality metric associated the source network node 810 to the threshold associated with the quality metric included in the one or more handover delay rules (e.g., a second threshold), and compare a source network node 810 scheduling rate to the threshold associated with the source network node 810 scheduling rate indicated in the one or more handover delay rules (e.g., a third threshold). If the predicted uplink packet arrival time does not satisfy the first threshold (e.g., is greater than or equal to the first threshold), the quality metric does not satisfy the second threshold (e.g., is less than or equal to the second threshold), or the source network node 810 scheduling rate does not satisfy the third threshold (e.g., is less than or equal to the third threshold) then the UE 805 may refrain from delaying CHO procedure (e.g., CHO procedure is not delayed). In other words, the handover is not delayed if the predicted uplink data packet arrival time is large, because the handover might be complete (or there may be minimal data interruption) by the time the uplink data burst arrives, if the signal quality is poor because the uplink data burst transmission may not be reliable, which may lead to retransmission, or if the scheduling rate is low which may mean that the uplink data bursts have a lower periodicity. If the predicted uplink packet arrival time satisfies the first threshold (e.g., is less than or equal to the first threshold), the quality metric satisfies the second threshold (e.g., is greater than or equal to the second threshold), and the source network node 810 scheduling rate does not satisfies the third threshold (e.g., is greater than or equal to the third threshold) then the source network node 810 may not delay the CHO procedure (e.g., CHO procedure is delayed). In other words, the handover is delayed if the predicted uplink data packet arrival time is small, because the data may arrive before handover is complete, if the signal quality is high because the uplink data burst transmission may be reliable, or if the scheduling rate is high which may mean that the uplink data bursts have a higher periodicity.

If the UE 805 determines to delay the CHO procedure in accordance with the fourth operation 835, then the UE 805 and/or the source network node 810 may perform a fifth operation 840 and/or a sixth operation 845 in which one or more uplink and/or downlink bursts are transmitted before performing the CHO procedure.

In the fifth operation 840, the source network node 810 may transmit, and the UE 805 may receive, a downlink data burst before the UE 805 performs the CHO procedure.

In the sixth operation 845, the UE 805 may transmit, and the source network node 810 may receive, an uplink data burst before the UE 805 performs the CHO procedure.

In a seventh operation 850, the UE 805 and the target network node 815 may perform the CHO procedure in accordance with the one or more CHO conditions being satisfied and in accordance with whether the UE 805 delayed the CHO procedure. For example, the CHO procedure may be performed in accordance with one or more aspects of example 400 to establish a wireless link between the UE 805 and the target network node 815.

If the UE 805 determines to delay the CHO procedure in accordance with the fourth operation 835, then the UE 805, the source network node 810, and/or the target network node 815 may perform an eighth operation 855, a ninth operation 860, and/or a tenth operation 865 in which one or more uplink and/or downlink bursts are transmitted after performing the CHO procedure.

In the eighth operation 855, the source network node 810 sends, and the target network node 815 receives, the downlink data burst. For example, the downlink data burst may be the same downlink data burst described in the fifth operation 840, however, the downlink data burst is forwarded to the target network node 815 based on the UE 805 not delaying the CHO procedure.

In the ninth operation 860, the target network node 815 may transmit, and the UE 805 may receive, the downlink data burst. In other words, the UE 805 receives the downlink data burst from the target network node 815 based on the source network node 810 not delaying the handover command. In some examples, the eighth operation 855 and the ninth operation 860 may be operations that are alternative to the fifth operation 840.

In a tenth operation 865, the UE 805 may transmit, and the target network node 815 may receive, the uplink data burst. For example, the uplink data burst may be a same uplink data burst described in the sixth operation 845, however the UE 805 transmits the uplink data burst to the target network node 815 based on the UE 805 not delaying the CHO procedure. In some examples, the tenth operation 865may be alternative to the sixth operation 845.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with data burst interval awareness for handover procedures.

As shown in FIG. 9, in some aspects, process 900 may include transmitting, to a source network node, a report that indicates a data burst interval and indicates whether to delay handover execution based at least in part on the data burst interval (block 910). For example, the UE (e.g., using transmission component 1304 and/or communication manager 1306, depicted in FIG. 13) may transmit, to a source network node, a report that indicates a data burst interval and indicates whether to delay handover execution based at least in part on the data burst interval, as described above.

As further shown in FIG. 9, in some aspects, process 900 may include receiving, from the source network node, a command associated with a handover from the source network node to a target network node, wherein the command is received before or after a data burst based at least in part on the data burst interval and one or more handover delay rules (block 920). For example, the UE (e.g., using reception component 1302 and/or communication manager 1306, depicted in FIG. 13) may receive, from the source network node, a command associated with a handover from the source network node to a target network node, wherein the command is received before or after a data burst based at least in part on the data burst interval and one or more handover delay rules, as described above.

As further shown in FIG. 9, in some aspects, process 900 may include performing the handover based at least in part on receiving the command (block 930). For example, the UE (e.g., using communication manager 1306, depicted in FIG. 13) may perform the handover based at least in part on receiving the command, as described above.

Process 900 may include additional aspects, such as any single aspect or any combination of aspects described below and/or in connection with one or more other processes described elsewhere herein.

In a first aspect, process 900 includes transmitting, to the source network node, capability information indicating support for data burst aware handover procedures, wherein transmitting the report is in accordance with the capability information.

In a second aspect, alone or in combination with the first aspect, process 900 includes receiving, from the source network node, an indication of the one or more handover delay rules based at least in part on the capability information.

In a third aspect, alone or in combination with one or more of the first and second aspects, the report further indicates a requested duration by which to delay the handover execution.

In a fourth aspect, alone or in combination with one or more of the first through third aspects, the handover is a layer 3 handover procedure, a layer 1 or layer 2 triggered mobility (LTM) procedure, a sequence handover, or a non-sequence handover and the one or more handover delay rules are based at least in part on one or more of a predicted arrival time of the data burst, a source network node scheduling rate, a measurement associated with the source network node, or a duration for delaying the handover.

In a fifth aspect, alone or in combination with one or more of the first through fourth aspects, process 900 includes receiving, from the source network node before the data burst, the command associated with the handover based at least in part on the report, wherein performing the handover is in accordance with the command, and transmitting, to the target network node after performing the handover, the data burst.

In a sixth aspect, alone or in combination with one or more of the first through fifth aspects, process 900 includes transmitting, to the source network node before the handover, the data burst based at least in part on the report, and receiving, from the source network node after the data burst, the command associated with the handover, wherein performing the handover is in accordance with the command.

In a seventh aspect, alone or in combination with one or more of the first through sixth aspects, process 900 includes receiving, from the source network node before the data burst, the command associated with the handover based at least in part on the report, wherein performing the handover is in accordance with the command, and receiving, from the target network node after performing the handover, the data burst.

In an eighth aspect, alone or in combination with one or more of the first through seventh aspects, process 900 includes receiving, from the source network node before the handover, the data burst based at least in part on the report, transmitting, to the source network node, a feedback communication that indicates successful reception of the data burst, and receiving, from the source network node after the data burst, the command associated with the handover based at least in part on the successful reception of the data burst, wherein performing the handover is in accordance with the command.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with data burst interval awareness for handover procedures.

As shown in FIG. 10, in some aspects, process 1000 may include receiving, from a source network node, a command indicating one or more conditions associated with a handover from the source network node to a target network node, wherein the command indicates one or more handover delay rules associated with whether to delay execution of the handover in accordance with a data burst interval (block 1010). For example, the UE (e.g., using reception component 1302 and/or communication manager 1306, depicted in FIG. 13) may receive, from a source network node, a command indicating one or more conditions associated with a handover from the source network node to a target network node, wherein the command indicates one or more handover delay rules associated with whether to delay execution of the handover in accordance with a data burst interval, as described above.

As further shown in FIG. 10, in some aspects, process 1000 may include performing, in accordance with the one or more conditions being satisfied, the handover to the target network node before or after a data burst based at least in part on the data burst interval and one or more handover delay rules (block 1020). For example, the UE (e.g., using communication manager 1306, depicted in FIG. 13) may perform, in accordance with the one or more conditions being satisfied, the handover to the target network node before or after a data burst based at least in part on the data burst interval and one or more handover delay rules, as described above.

Process 1000 may include additional aspects, such as any single aspect or any combination of aspects described below and/or in connection with one or more other processes described elsewhere herein.

In a first aspect, process 1000 includes transmitting, to the source network node, capability information indicating support for data burst aware handover procedures, wherein receiving the command that indicates the one or more handover delay rules is in accordance with the capability information.

In a second aspect, alone or in combination with the first aspect, the one or more handover delay rules are based at least in part on one or more of a predicted arrival time of the data burst, a source network node scheduling rate, a measurement associated with the source network node, or a duration for delaying the handover.

In a third aspect, alone or in combination with one or more of the first and second aspects, process 1000 includes performing, with the target network node, the handover before the data burst based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold, and transmitting, to the target network node after the handover, the data burst.

In a fourth aspect, alone or in combination with one or more of the first through third aspects, process 1000 includes transmitting, to the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

In a fifth aspect, alone or in combination with one or more of the first through fourth aspects, process 1000 includes receiving, from the source network node, control information scheduling the data burst, wherein the predicted arrival time of the data burst and the source network node scheduling rate are based at least in part on the control information, and performing, with the target network node, the handover based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

In a sixth aspect, alone or in combination with one or more of the first through fifth aspects, process 1000 includes receiving, from the source network node, control information scheduling the data burst, wherein the predicted arrival time of the data burst and the source network node scheduling rate are based at least in part on the control information, and receiving, from the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a source network node or an apparatus of a source network node, in accordance with the present disclosure. Example process 1100 is an example where the apparatus or the source network node (e.g., source network node 110) performs operations associated with data burst interval awareness for handover procedures.

As shown in FIG. 11, in some aspects, process 1100 may include receiving, from a UE, a report that indicates a data burst interval and indicates whether to delay handover execution based at least in part on the data burst interval (block 1110). For example, the source network node (e.g., using reception component 1402 and/or communication manager 1406, depicted in FIG. 14) may receive, from a UE, a report that indicates a data burst interval and indicates whether to delay handover execution based at least in part on the data burst interval, as described above.

As further shown in FIG. 11, in some aspects, process 1100 may include transmitting, to the UE, a command associated with a handover from the source network node to a target network node, wherein the command is received before or after a data burst based at least in part on the data burst interval and one or more handover delay rules (block 1120). For example, the source network node (e.g., using transmission component 1404 and/or communication manager 1406, depicted in FIG. 14) may transmit, to the UE, a command associated with a handover from the source network node to a target network node, wherein the command is received before or after a data burst based at least in part on the data burst interval and one or more handover delay rules, as described above.

As further shown in FIG. 11, in some aspects, process 1100 may include releasing, in accordance with the handover, a wireless connection with the UE before or after the data burst, based at least in part on the command (block 1130). For example, the source network node (e.g., using communication manager 1406, depicted in FIG. 14) may release, in accordance with the handover, a wireless connection with the UE before or after the data burst, based at least in part on the command, as described above.

Process 1100 may include additional aspects, such as any single aspect or any combination of aspects described below and/or in connection with one or more other processes described elsewhere herein.

In a first aspect, process 1100 includes receiving, from the UE, capability information indicating support for data burst aware handover procedures, wherein receiving the report is in accordance with the capability information.

In a second aspect, alone or in combination with the first aspect, process 1100 includes transmitting, to the UE, an indication of the one or more handover delay rules based at least in part on the capability information.

In a third aspect, alone or in combination with one or more of the first and second aspects, the report further indicates a requested duration by which to delay the handover execution.

In a fourth aspect, alone or in combination with one or more of the first through third aspects, the handover is a layer 3 handover procedure or a layer 1 or layer 2 triggered mobility (LTM) procedure, a sequence handover, or a non-sequence handover and the one or more handover delay rules are based at least in part on one or more of a predicted arrival time of the data burst, a source network node scheduling rate, a measurement associated with the source network node, or a duration for delaying the handover.

In a fifth aspect, alone or in combination with one or more of the first through fourth aspects, process 1100 includes transmitting, to the UE, the command before the data burst based at least in part on the predicted arrival time of the data burst not satisfying a first threshold, the measurement associated with the source network node not satisfying a second threshold, or the duration for delaying the handover not satisfying a third threshold, wherein releasing the wireless connection is based at least in part on transmitting the command.

In a sixth aspect, alone or in combination with one or more of the first through fifth aspects, process 1100 includes receiving, from the UE before the handover, the data burst based at least in part on the predicted arrival time of the data burst satisfying a first threshold, the measurement associated with the source network node satisfying a second threshold, and the duration for delaying the handover satisfying a third threshold, and transmitting, to the UE after the data burst, the command, wherein delay handover is based at least in part on transmitting the command.

In a seventh aspect, alone or in combination with one or more of the first through sixth aspects, process 1100 includes transmitting, to the UE before the handover, the data burst based at least in part on a predicted arrival time of the data burst not satisfying a first threshold, the measurement associated with the source network node not satisfying a second threshold, or the duration for delaying the handover not satisfying a third threshold, receiving, from the UE, a feedback communication that indicates successful reception of the data burst, and transmitting, to the UE after the data burst, the command based at least in part on the successful reception of the data burst, wherein releasing the wireless connection is based at least in part on transmitting the command.

In an eighth aspect, alone or in combination with one or more of the first through seventh aspects, process 1100 includes transmitting, to the UE before the data burst, the command based at least in part on a predicted arrival time of the data burst satisfying a first threshold, the measurement associated with the source network node satisfying a second threshold, and the duration for delaying the handover satisfying a third threshold, wherein releasing the wireless connection is based at least in part on transmitting the command, and transmitting, to the target network node after performing the handover, the data burst for transmission to the UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a source network node or an apparatus of a source network node, in accordance with the present disclosure. Example process 1200 is an example where the apparatus or the source network node (e.g., source network node 110) performs operations associated with data burst interval awareness for handover procedures.

As shown in FIG. 12, in some aspects, process 1200 may include transmitting, to a UE, a command indicating one or more conditions associated with a handover of the UE from the source network node to a target network node, wherein the command indicates one or more handover delay rules associated with whether to delay execution of the handover in accordance with a data burst interval (block 1210). For example, the source network node (e.g., using transmission component 1404 and/or communication manager 1406, depicted in FIG. 14) may transmit, to a UE, a command indicating one or more conditions associated with a handover of the UE from the source network node to a target network node, wherein the command indicates one or more handover delay rules associated with whether to delay execution of the handover in accordance with a data burst interval, as described above.

As further shown in FIG. 12, in some aspects, process 1200 may include releasing, in accordance with the handover for the UE to the target network node and in accordance with the one or more conditions being satisfied, a wireless connection with the UE before or after a data burst, based at least in part on the data burst interval and one or more handover delay rules (block 1220). For example, the source network node (e.g., using communication manager 1406, depicted in FIG. 14) may release, in accordance with the handover for the UE to the target network node and in accordance with the one or more conditions being satisfied, a wireless connection with the UE before or after a data burst, based at least in part on the data burst interval and one or more handover delay rules, as described above.

Process 1200 may include additional aspects, such as any single aspect or any combination of aspects described below and/or in connection with one or more other processes described elsewhere herein.

In a first aspect, process 1200 includes receiving, from the UE, capability information indicating support for data burst aware handover procedures, wherein transmitting the command that indicates the one or more handover delay rules is in accordance with the capability information.

In a second aspect, alone or in combination with the first aspect, the one or more handover delay rules are based at least in part on one or more of a predicted arrival time of the data burst, a source network node scheduling rate, a measurement associated with the source network node, or a duration for delaying the handover.

In a third aspect, alone or in combination with one or more of the first and second aspects, process 1200 includes releasing, with the UE, the wireless connection in accordance with the handover before the data burst based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

In a fourth aspect, alone or in combination with one or more of the first through third aspects, process 1200 includes receiving, from the UE before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

In a fifth aspect, alone or in combination with one or more of the first through fourth aspects, process 1200 includes transmitting, to the UE, control information scheduling the data burst, wherein the predicted arrival time of the data burst and the source network node scheduling rate are based at least in part on the control information, releasing, with the UE, the wireless connection in accordance with the handover based at least in part on a predicted arrival time of the data burst not satisfying a first threshold, the source network node scheduling rate not satisfying a second threshold, the measurement associated with the source network node not satisfying a third threshold, or the duration for delaying the handover not satisfying a fourth threshold, and transmitting, to the target network node after the handover, the data burst for transmission to the UE.

In a sixth aspect, alone or in combination with one or more of the first through fifth aspects, process 1200 includes transmitting, to the UE, control information scheduling the data burst, wherein the predicted arrival time of the data burst and the source network node scheduling rate are based at least in part on the control information, and transmitting, to the UE before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 3 through 8. Additionally, or alternatively, the apparatus 1300 may be configured to perform one or more processes described herein, such as process 900 of FIG. 9, process 1000 of FIG. 10, or a combination thereof. In some aspects, the apparatus 1300 and/or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a source network node, a report that indicates a data burst interval and indicates whether to delay handover execution based at least in part on the data burst interval. The reception component 1302 may receive, from the source network node, a command associated with a handover from the source network node to a target network node, wherein the command is received before or after a data burst based at least in part on the data burst interval and one or more handover delay rules. The communication manager 1306 may perform the handover based at least in part on receiving the command.

The transmission component 1304 may transmit, to the source network node, capability information indicating support for data burst aware handover procedures, wherein transmitting the report is in accordance with the capability information.

The reception component 1302 may receive, from the source network node, an indication of the one or more handover delay rules based at least in part on the capability information.

The reception component 1302 may receive, from the source network node before the data burst, the command associated with the handover based at least in part on the report, wherein performing the handover is in accordance with the command.

The transmission component 1304 may transmit, to the target network node after performing the handover, the data burst.

The transmission component 1304 may transmit, to the source network node before the handover, the data burst based at least in part on the report.

The reception component 1302 may receive, from the source network node after the data burst, the command associated with the handover, wherein performing the handover is in accordance with the command.

The reception component 1302 may receive, from the source network node before the data burst, the command associated with the handover based at least in part on the report, wherein performing the handover is in accordance with the command.

The reception component 1302 may receive, from the target network node after performing the handover, the data burst.

The reception component 1302 may receive, from the source network node before the handover, the data burst based at least in part on the report.

The transmission component 1304 may transmit, to the source network node, a feedback communication that indicates successful reception of the data burst.

The reception component 1302 may receive, from the source network node after the data burst, the command associated with the handover based at least in part on the successful reception of the data burst, wherein performing the handover is in accordance with the command.

The reception component 1302 may receive, from a source network node, a command indicating one or more conditions associated with a handover from the source network node to a target network node, wherein the command indicates one or more handover delay rules associated with whether to delay execution of the handover in accordance with a data burst interval. The communication manager 1306 may perform, in accordance with the one or more conditions being satisfied, the handover to the target network node before or after a data burst based at least in part on the data burst interval and one or more handover delay rules.

The transmission component 1304 may transmit, to the source network node, capability information indicating support for data burst aware handover procedures, wherein receiving the command that indicates the one or more handover delay rules is in accordance with the capability information.

The communication manager 1306 may perform, with the target network node, the handover before the data burst based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

The transmission component 1304 may transmit, to the target network node after the handover, the data burst.

The transmission component 1304 may transmit, to the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

The reception component 1302 may receive, from the source network node, control information scheduling the data burst, wherein the predicted arrival time of the data burst and the source network node scheduling rate are based at least in part on the control information.

The communication manager 1306 may perform, with the target network node, the handover based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

The reception component 1302 may receive, from the source network node, control information scheduling the data burst, wherein the predicted arrival time of the data burst and the source network node scheduling rate are based at least in part on the control information.

The reception component 1302 may receive, from the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a source network node, or a source network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the source network node.

In some aspects, the apparatus 1400 may be configured to perform one or more operations described herein in connection with FIGS. 3 through 8. Additionally, or alternatively, the apparatus 1400 may be configured to perform one or more processes described herein, such as process 1100 of FIG. 11, process 1200 of FIG. 12, or a combination thereof. In some aspects, the apparatus 1400 and/or one or more components shown in FIG. 14 may include one or more components of the source network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the source network node described above in connection with FIG. 1, such as a radio, one or more RF chains, one or more transceivers, or one or more modems, each of which may in turn be coupled with one or more antennas of the source network node. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the source network node described above in connection with FIG. 1, such as a radio, one or more RF chains, one or more transceivers, or one or more modems, each of which may in turn be coupled with one or more antennas of the source network node described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, from a UE, a report that indicates a data burst interval and indicates whether to delay handover execution based at least in part on the data burst interval. The transmission component 1404 may transmit, to the UE, a command associated with a handover from the source network node to a target network node, wherein the command is received before or after a data burst based at least in part on the data burst interval and one or more handover delay rules. The communication manager 1406 may release, in accordance with the handover, a wireless connection with the UE before or after the data burst, based at least in part on the command.

The reception component 1402 may receive, from the UE, capability information indicating support for data burst aware handover procedures, wherein receiving the report is in accordance with the capability information.

The transmission component 1404 may transmit, to the UE, an indication of the one or more handover delay rules based at least in part on the capability information.

The transmission component 1404 may transmit, to the UE, the command before the data burst based at least in part on the predicted arrival time of the data burst not satisfying a first threshold, the measurement associated with the source network node not satisfying a second threshold, or the duration for delaying the handover not satisfying a third threshold, wherein releasing the wireless connection is based at least in part on transmitting the command.

The reception component 1402 may receive, from the UE before the handover, the data burst based at least in part on the predicted arrival time of the data burst satisfying a first threshold, the measurement associated with the source network node satisfying a second threshold, and the duration for delaying the handover satisfying a third threshold.

The transmission component 1404 may transmit, to the UE after the data burst, the command, wherein delay handover is based at least in part on transmitting the command.

The transmission component 1404 may transmit, to the UE before the handover, the data burst based at least in part on a predicted arrival time of the data burst not satisfying a first threshold, the measurement associated with the source network node not satisfying a second threshold, or the duration for delaying the handover not satisfying a third threshold.

The reception component 1402 may receive, from the UE, a feedback communication that indicates successful reception of the data burst.

The transmission component 1404 may transmit, to the UE after the data burst, the command based at least in part on the successful reception of the data burst, wherein releasing the wireless connection is based at least in part on transmitting the command.

The transmission component 1404 may transmit, to the UE before the data burst, the command based at least in part on a predicted arrival time of the data burst satisfying a first threshold, the measurement associated with the source network node satisfying a second threshold, and the duration for delaying the handover satisfying a third threshold, wherein releasing the wireless connection is based at least in part on transmitting the command.

The transmission component 1404 may transmit, to the target network node after performing the handover, the data burst for transmission to the UE.

The transmission component 1404 may transmit, to a UE, a command indicating one or more conditions associated with a handover of the UE from the source network node to a target network node, wherein the command indicates one or more handover delay rules associated with whether to delay execution of the handover in accordance with a data burst interval. The communication manager 1406 may release, in accordance with the handover for the UE to the target network node and in accordance with the one or more conditions being satisfied, a wireless connection with the UE before or after a data burst, based at least in part on the data burst interval and one or more handover delay rules.

The reception component 1402 may receive, from the UE, capability information indicating support for data burst aware handover procedures, wherein transmitting the command that indicates the one or more handover delay rules is in accordance with the capability information.

The communication manager 1406 may release, with the UE, the wireless connection in accordance with the handover before the data burst based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

The reception component 1402 may receive, from the UE before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

The transmission component 1404 may transmit, to the UE, control information scheduling the data burst, wherein the predicted arrival time of the data burst and the source network node scheduling rate are based at least in part on the control information.

The communication manager 1406 may release, with the UE, the wireless connection in accordance with the handover based at least in part on a predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

The transmission component 1404 may transmit, to the target network node after the handover, the data burst for transmission to the UE.

The transmission component 1404 may transmit, to the UE, control information scheduling the data burst, wherein the predicted arrival time of the data burst and the source network node scheduling rate are based at least in part on the control information.

The transmission component 1404 may transmit, to the UE before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: transmitting, to a source network node, a report that indicates a data burst interval and indicates whether to delay handover execution based at least in part on the data burst interval; receiving, from the source network node, a command associated with a handover from the source network node to a target network node, wherein the command is received before or after a data burst based at least in part on the data burst interval and one or more handover delay rules; and performing the handover based at least in part on receiving the command.

Aspect 2: The method of Aspect 1, further comprising: transmitting, to the source network node, capability information indicating support for data burst aware handover procedures, wherein transmitting the report is in accordance with the capability information.

Aspect 3: The method of Aspect 2, further comprising: receiving, from the source network node, an indication of the one or more handover delay rules based at least in part on the capability information.

Aspect 4: The method of any of Aspects 1-3, wherein the report further indicates a requested duration by which to delay the handover execution.

Aspect 5: The method of any of Aspects 1-4, wherein the handover is a layer 3 handover procedure, a layer 1 or layer 2 triggered mobility (LTM) procedure, a sequence handover, or a non-sequence handover and the one or more handover delay rules are based at least in part on one or more of a predicted arrival time of the data burst, a source network node scheduling rate, a measurement associated with the source network node, or a duration for delaying the handover.

Aspect 6: The method of Aspect 5, further comprising: receiving, from the source network node before the data burst, the command associated with the handover based at least in part on the report, wherein performing the handover is in accordance with the command; and transmitting, to the target network node after performing the handover, the data burst.

Aspect 7: The method of Aspect 5, further comprising: transmitting, to the source network node before the handover, the data burst based at least in part on the report; and receiving, from the source network node after the data burst, the command associated with the handover, wherein performing the handover is in accordance with the command.

Aspect 8: The method of Aspect 5, further comprising: receiving, from the source network node before the data burst, the command associated with the handover based at least in part on the report, wherein performing the handover is in accordance with the command; and receiving, from the target network node after performing the handover, the data burst.

Aspect 9: The method of Aspect 5, further comprising: receiving, from the source network node before the handover, the data burst based at least in part on the report; transmitting, to the source network node, a feedback communication that indicates successful reception of the data burst; and receiving, from the source network node after the data burst, the command associated with the handover based at least in part on the successful reception of the data burst, wherein performing the handover is in accordance with the command.

Aspect 10: A method of wireless communication performed by a UE, comprising: receiving, from a source network node, a command indicating one or more conditions associated with a handover from the source network node to a target network node, wherein the command indicates one or more handover delay rules associated with whether to delay execution of the handover in accordance with a data burst interval; and performing, in accordance with the one or more conditions being satisfied, the handover to the target network node before or after a data burst based at least in part on the data burst interval and one or more handover delay rules.

Aspect 11: The method of Aspect 10, further comprising: transmitting, to the source network node, capability information indicating support for data burst aware handover procedures, wherein receiving the command that indicates the one or more handover delay rules is in accordance with the capability information.

Aspect 12: The method of any of Aspects 10-11, wherein the one or more handover delay rules are based at least in part on one or more of a predicted arrival time of the data burst, a source network node scheduling rate, a measurement associated with the source network node, or a duration for delaying the handover.

Aspect 13: The method of Aspect 12, further comprising: performing, with the target network node, the handover before the data burst based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold; and transmitting, to the target network node after the handover, the data burst.

Aspect 14: The method of Aspect 12, further comprising: transmitting, to the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

Aspect 15: The method of Aspect 12, further comprising: receiving, from the source network node, control information scheduling the data burst, wherein the predicted arrival time of the data burst and the source network node scheduling rate are based at least in part on the control information; and performing, with the target network node, the handover based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

Aspect 16: The method of Aspect 12, further comprising: receiving, from the source network node, control information scheduling the data burst, wherein the predicted arrival time of the data burst and the source network node scheduling rate are based at least in part on the control information; and receiving, from the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

Aspect 17: A method of wireless communication performed by a source network node, comprising: receiving, from a UE, a report that indicates a data burst interval and indicates whether to delay handover execution based at least in part on the data burst interval; transmitting, to the UE, a command associated with a handover from the source network node to a target network node, wherein the command is received before or after a data burst based at least in part on the data burst interval and one or more handover delay rules; and releasing, in accordance with the handover, a wireless connection with the UE before or after the data burst, based at least in part on the command.

Aspect 18: The method of Aspect 17, further comprising: receiving, from the UE, capability information indicating support for data burst aware handover procedures, wherein receiving the report is in accordance with the capability information.

Aspect 19: The method of Aspect 18, further comprising: transmitting, to the UE, an indication of the one or more handover delay rules based at least in part on the capability information.

Aspect 20: The method of any of Aspects 17-19, wherein the report further indicates a requested duration by which to delay the handover execution.

Aspect 21: The method of any of Aspects 17-20, wherein the handover is a layer 3 handover procedure or a layer 1 or layer 2 triggered mobility (LTM) procedure, a sequence handover, or a non-sequence handover and the one or more handover delay rules are based at least in part on one or more of a predicted arrival time of the data burst, a source network node scheduling rate, a measurement associated with the source network node, or a duration for delaying the handover.

Aspect 22: The method of Aspect 21, further comprising: transmitting, to the UE, the command before the data burst based at least in part on the predicted arrival time of the data burst not satisfying a first threshold, the measurement associated with the source network node not satisfying a second threshold, or the duration for delaying the handover not satisfying a third threshold, wherein releasing the wireless connection is based at least in part on transmitting the command.

Aspect 23: The method of Aspect 21, further comprising: receiving, from the UE before the handover, the data burst based at least in part on the predicted arrival time of the data burst satisfying a first threshold, the measurement associated with the source network node satisfying a second threshold, and the duration for delaying the handover satisfying a third threshold; and transmitting, to the UE after the data burst, the command, wherein delay handover is based at least in part on transmitting the command.

Aspect 24: The method of Aspect 21, further comprising: transmitting, to the UE before the handover, the data burst based at least in part on a predicted arrival time of the data burst not satisfying a first threshold, the measurement associated with the source network node not satisfying a second threshold, or the duration for delaying the handover not satisfying a third threshold; receiving, from the UE, a feedback communication that indicates successful reception of the data burst; and transmitting, to the UE after the data burst, the command based at least in part on the successful reception of the data burst, wherein releasing the wireless connection is based at least in part on transmitting the command.

Aspect 25: The method of Aspect 21, further comprising: transmitting, to the UE before the data burst, the command based at least in part on a predicted arrival time of the data burst satisfying a first threshold, the measurement associated with the source network node satisfying a second threshold, and the duration for delaying the handover satisfying a third threshold, wherein releasing the wireless connection is based at least in part on transmitting the command; and transmitting, to the target network node after performing the handover, the data burst for transmission to the UE.

Aspect 26: A method of wireless communication performed by a source network node, comprising: transmitting, to a UE, a command indicating one or more conditions associated with a handover of the UE from the source network node to a target network node, wherein the command indicates one or more handover delay rules associated with whether to delay execution of the handover in accordance with a data burst interval; and releasing, in accordance with the handover for the UE to the target network node and in accordance with the one or more conditions being satisfied, a wireless connection with the UE before or after a data burst, based at least in part on the data burst interval and one or more handover delay rules.

Aspect 27: The method of Aspect 26, further comprising: receiving, from the user equipment (UE), capability information indicating support for data burst aware handover procedures, wherein transmitting the command that indicates the one or more handover delay rules is in accordance with the capability information.

Aspect 28: The method of any of Aspects 26-27, wherein the one or more handover delay rules are based at least in part on one or more of a predicted arrival time of the data burst, a source network node scheduling rate, a measurement associated with the source network node, or a duration for delaying the handover.

Aspect 29: The method of Aspect 28, further comprising: releasing, with the UE, the wireless connection in accordance with the handover before the data burst based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

Aspect 30: The method of Aspect 28, further comprising: receiving, from the UE before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

Aspect 31: The method of Aspect 28, further comprising: transmitting, to the UE, control information scheduling the data burst, wherein the predicted arrival time of the data burst and the source network node scheduling rate are based at least in part on the control information; releasing, with the UE, the wireless connection in accordance with the handover based at least in part on a predicted arrival time of the data burst not satisfying a first threshold, the source network node scheduling rate not satisfying a second threshold, the measurement associated with the source network node not satisfying a third threshold, or the duration for delaying the handover not satisfying a fourth threshold; and transmitting, to the target network node after the handover, the data burst for transmission to the UE.

Aspect 32: The method of Aspect 28, further comprising: transmitting, to the UE, control information scheduling the data burst, wherein the predicted arrival time of the data burst and the source network node scheduling rate are based at least in part on the control information; and transmitting, to the UE before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to a source network node, a report that indicates a data burst interval and indicates whether to delay handover execution based at least in part on the data burst interval;
receive, from the source network node, a command associated with a handover from the source network node to a target network node, wherein the command is received before or after a data burst based at least in part on the data burst interval and one or more handover delay rules; and
perform the handover based at least in part on receiving the command.

2. The UE of claim 1, wherein the one or more processors are further configured to cause the UE to:
transmit, to the source network node, capability information indicating support for data burst aware handover procedures, wherein transmitting the report is in accordance with the capability information.

3. The UE of claim 2, wherein the one or more processors are further configured to cause the UE to:
receive, from the source network node, an indication of the one or more handover delay rules based at least in part on the capability information.

4. The UE of claim 1, wherein the report further indicates a requested duration by which to delay the handover execution.

5. The UE of claim 1, wherein the handover is a layer 3 handover procedure, a layer 1 or layer 2 triggered mobility (LTM) procedure, a sequence handover, or a non-sequence handover and the one or more handover delay rules are based at least in part on one or more of a predicted arrival time of the data burst, a source network node scheduling rate, a measurement associated with the source network node, or a duration for delaying the handover.

6. The UE of claim 5, wherein the one or more processors are further configured to cause the UE to:
receive, from the source network node before the data burst, the command associated with the handover based at least in part on the report, wherein performing the handover is in accordance with the command; and
transmit, to the target network node after performing the handover, the data burst.

7. The UE of claim 5, wherein the one or more processors are further configured to cause the UE to:
transmit, to the source network node before the handover, the data burst based at least in part on the report; and
receive, from the source network node after the data burst, the command associated with the handover, wherein performing the handover is in accordance with the command.

8. The UE of claim 5, wherein the one or more processors are further configured to cause the UE to:
receive, from the source network node before the data burst, the command associated with the handover based at least in part on the report, wherein performing the handover is in accordance with the command; and
receive, from the target network node after performing the handover, the data burst.

9. The UE of claim 5, wherein the one or more processors are further configured to cause the UE to:
receive, from the source network node before the handover, the data burst based at least in part on the report;
transmit, to the source network node, a feedback communication that indicates successful reception of the data burst; and
receive, from the source network node after the data burst, the command associated with the handover based at least in part on the successful reception of the data burst, wherein performing the handover is in accordance with the command.

10. A UE for wireless communication, comprising:
one or more memories; and
one or more processors, coupled to the one or more memories, configured to cause the UE to:
receive, from a source network node, a command indicating one or more conditions associated with a handover from the source network node to a target network node, wherein the command indicates one or more handover delay rules associated with whether to delay execution of the handover in accordance with a data burst interval; and
perform, in accordance with the one or more conditions being satisfied, the handover to the target network node before or after a data burst based at least in part on the data burst interval and one or more handover delay rules.

11. The UE of claim 10, wherein the one or more processors are further configured to cause the UE to:
transmit, to the source network node, capability information indicating support for data burst aware handover procedures, wherein receiving the command that indicates the one or more handover delay rules is in accordance with the capability information.

12. The UE of claim 10, wherein the one or more handover delay rules are based at least in part on one or more of a predicted arrival time of the data burst, a source network node scheduling rate, a measurement associated with the source network node, or a duration for delaying the handover.

13. The UE of claim 12, wherein the one or more processors are further configured to cause the UE to:
perform, with the target network node, the handover before the data burst based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold; and
transmit, to the target network node after the handover, the data burst.

14. The UE of claim 12, wherein the one or more processors are further configured to cause the UE to:
transmit, to the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

15. The UE of claim 12, wherein the one or more processors are further configured to cause the UE to:
receive, from the source network node, control information scheduling the data burst, wherein the predicted arrival time of the data burst and the source network node scheduling rate are based at least in part on the control information; and
perform, with the target network node, the handover based at least in part on the predicted arrival time of the data burst not satisfying a first threshold, the source network node scheduling rate not satisfying a second threshold, the measurement associated with the source network node not satisfying a third threshold, or the duration for delaying the handover not satisfying a fourth threshold.

16. The UE of claim 12, wherein the one or more processors are further configured to cause the UE to:
receive, from the source network node, control information scheduling the data burst, wherein the predicted arrival time of the data burst and the source network node scheduling rate are based at least in part on the control information; and
receive, from the source network node before the handover, the data burst based at least in part on the predicted arrival time of the data burst satisfying a first threshold, the source network node scheduling rate satisfying a second threshold, the measurement associated with the source network node satisfying a third threshold, and the duration for delaying the handover satisfying a fourth threshold.

17. A method of wireless communication performed by a user equipment (UE), comprising:
transmitting, to a source network node, a report that indicates a data burst interval and indicates whether to delay handover execution based at least in part on the data burst interval;
receiving, from the source network node, a command associated with a handover from the source network node to a target network node, wherein the command is received before or after a data burst based at least in part on the data burst interval and one or more handover delay rules; and
performing the handover based at least in part on receiving the command.

18. The method of claim 17, further comprising:
transmitting, to the source network node, capability information indicating support for data burst aware handover procedures, wherein transmitting the report is in accordance with the capability information.

19. The method of claim 18, further comprising:
receiving, from the source network node, an indication of the one or more handover delay rules based at least in part on the capability information.

20. The method of claim 17, wherein the report further indicates a requested duration by which to delay the handover execution.
